(19) United States
(12) Patent Application Publication
(10) Pub. No.: US 2024/0160298 A1
(43) Pub. Date: May 16, 2024

(54) POINT AND GESTURE CONTROL OF REMOTE DEVICES

(71) Applicant: Google LLC, Mountain View, CA (US)

(72) Inventors: Rajeev Nongpiur, Mountain View, CA (US); Roy Want, Los Altos, CA (US); Qian Zhang, Santa Clara, CA (US); JinJie Chen, Sunnyvale, CA (US); Der-Woei Wu, Mountain View, CA (US); Cody Wortham, San Francisco, CA (US); Aleksandr Salo, Santa Clara, CA (US); Marie Vachovsky, Mountain View, CA (US)

(73) Assignee: Google LLC, Mountain View, CA (US)

(21) Appl. No.: 18/070,695

(22) Filed: Nov. 29, 2022

Related U.S. Application Data
(63) Continuation of application No. PCT/US2022/050118, filed on Nov. 16, 2022.

(51) Int. Cl. G06F 3/0354; G06F 3/01

(52) U.S. Cl. CPC G06F 3/0354; G06F 3/017

(57) ABSTRACT

Techniques for controlling a remotely controllable device are described. In an example, a mobile device detects a remotely controllable device, measures a distance and direction from the mobile device to the remotely controllable device, and determines from the distance and direction that the mobile device is pointing at the remotely controllable device. In response to determining that the mobile device is in a handheld position, is pointing at the remotely controllable device, or both, the mobile device monitors for a movement of the mobile device according to a prescribed gesture. In response to detecting that the mobile device was moved according to the prescribed gesture, the mobile device presents a collection of selectable actions control operations of the remotely controllable device.

### CROSS-REFERENCE TO RELATED APPLICATIONS

This application is a continuation of International Application No. PCT/US2022/050118, filed Nov. 16, 2022, the entire contents of which are incorporated herein by reference.

### BACKGROUND

Wirelessly connected devices can be useful for many reasons, including their ability to be controlled remotely from other devices. However, initiating control over a particular device, or switching control from one device to another, can be difficult. Embodiments detailed herein provide effective techniques for initiating control, and subsequently controlling, wireless connected devices from mobile devices.

### SUMMARY

Various embodiments are described related to point and gesture control of remote devices. In some embodiments, a method for controlling a remotely controllable device is described. The method may comprise detecting, by a mobile device, a remotely controllable device. The method may further comprise determining, by the mobile device, that the mobile device is in a handheld position. The method may further comprise measuring, by the mobile device, using a first wireless communication protocol, a distance and a direction from the mobile device to the remotely controllable device. The method may further comprise determining, from the distance and the direction, that the mobile device is pointing at the remotely controllable device. In response to determining that the mobile device is in a handheld position, that the mobile device is pointing at the remotely controllable device, or both, the method may further comprise monitoring, by the mobile device, for a movement of the mobile device according to a prescribed gesture. The method may further comprise detecting, by the mobile device, that the mobile device was moved according to the prescribed gesture while the mobile device was pointed at the remotely controllable device. The method may further comprise presenting, at a display of the mobile device and in response to detecting that the mobile device was moved according to the prescribed gesture, a first collection of selectable actions to control one or more operations of the remotely controllable device.

Embodiments of such a method may further comprise, in response to determining that the mobile device is in a handheld position, increasing a scan rate of a first wireless communication component associated with the first wireless communication protocol from a first frequency to a second frequency higher than the first frequency. The method may further comprise detecting, by the mobile device using a motion sensor, one or more movements of the mobile device. In some embodiments, determining that the mobile device is in the handheld position is based at least in part on the one or more movements of the mobile device.

In some embodiments, the method further comprises receiving, at the display of the mobile device, a selection of a first action of the first collection of selectable actions corresponding to a first operation of the one or more operations. In response to receiving the selection of the first action, the method may further comprise transmitting, by the mobile device using a second wireless communication protocol different from the first wireless communication protocol, a command to control the first operation of the remotely controllable device.

In some embodiments, the method further comprises detecting, by the mobile device, that the mobile device was moved according to a second prescribed gesture associated with a first action of the first collection of selectable actions corresponding to a first operation of the one or more operations while the mobile device was pointed at the remotely controllable device. In response to detecting that the mobile device was moved according to the second prescribed gesture, the method may further comprise transmitting, by the mobile device using a second wireless communication protocol different from the first wireless communication protocol, a command to control the first operation of the remotely controllable device.

In some embodiments, the method further comprises detecting, by the mobile device, a plurality of remotely controllable devices comprising the remotely controllable device. The method may further comprise determining that the mobile device is pointing at a second remotely controllable device of the plurality of remotely controllable devices. The method may further comprise detecting, by the mobile device, that the mobile device was moved according to the prescribed gesture while the mobile device was pointed at the second remotely controllable device. The method may further comprise presenting, at the display of the mobile device, a second collection of selectable actions to control one or more operations of the second remotely controllable device.

In some embodiments, the method further comprises detecting, by the mobile device, a second remotely controllable devices. The method may further comprise measuring, by the mobile device, a second distance and a second direction from the mobile device to the second remotely controllable device. In some embodiments, determining that the mobile device is pointing at the remotely controllable device is further based on the second distance and the second direction from the mobile device to the second remotely controllable device, and a third distance from the remotely controllable device to the second remotely controllable device.

In some embodiments, the method further comprises determining, by the mobile device, that the mobile device is approved to control the remotely controllable device, wherein the first collection of selectable actions is presented in further response to determining that the mobile device is approved to control the remotely controllable device. In some embodiments, the first wireless communication protocol uses ultra-wideband communications between devices.

In some embodiments, a smart environment system is described. The system may comprise a remote device configured to be controlled remotely via one or more wireless communication protocols. The system may further comprise a mobile device comprising one or more processors and a memory communicatively coupled with and readable by the one or more processors and having stored therein processor-readable instructions which, when executed by the one or more processors, cause the one or more processors to detect the remote device. The instructions may further cause the one or more processors to determine that the mobile device is in a handheld position. The instructions may further cause the one or more processors to measure, using a first wireless communication protocol of the one or more wireless communication protocols, a distance and direction from the mobile device to the remote device. The instructions may further cause the one or more processors to determine, from the distance and the direction, that the mobile device is pointing at the remote device. The instructions may further cause the one or more processors to monitor, in response to determining that the mobile device is in a handheld position, that the mobile device is pointing at the remote device, or both, for a movement of the mobile device according to a prescribed gesture. The instructions may further cause the one or more processors to detect that the mobile device was moved according to the prescribed gesture while the mobile device was pointed at the remote device. The instructions may further cause the one or more processors to present, at a display of the mobile device and in response to detecting that the mobile device was moved according to the prescribed gesture, a first collection of selectable actions to control one or more operations of the remote device.

Embodiments of such a system may further comprise a plurality of remote devices comprising the remote device. In some embodiments, the instructions further cause the one or more processors to detect the plurality of remote devices, and measure, using the first wireless communication protocol, respective distances and directions from the mobile device to each of the plurality of remote devices. In some embodiments, the system may further comprise a hub device configured to transmit one or more commands from the mobile device to the remote device in response to a user selection of a first action of the first collection of selectable actions, and the instructions further cause the one or more processors to determine a second distance and a second direction from the mobile device to the hub device, wherein determining that the mobile device is pointing at the remote device is further based on the second distance and the second direction from the mobile device to the hub device, and a third distance from the remote device to the hub device.

In some embodiments, the remote device is a smart speaker configured to control media playback and the first collection of selectable actions includes a first action that causes a transfer of media playback by the mobile device to the smart speaker. In some embodiments, the remote device is a smart thermostat configured to control one or more operations of a heating, ventilation, and air-conditioning (HVAC) system, and the first collection of selectable actions includes a first action that causes the smart thermostat to adjust a setpoint temperature associated with the HVAC system. In some embodiments, the remote device is a security camera configured to record audio, video, or both, in a physical environment and the first collection of selectable actions includes a first action that causes the mobile device to display historical audio, video, or both recorded by the security camera.

In some embodiments, a non-transitory processor-readable medium is described. The medium may comprise processor-readable instructions configured to cause one or more processors to detect, by a mobile device, a remotely controllable device. The one or more processors may determine that the mobile device is in a handheld position. The one or more processors may measure a distance and a direction from the mobile device to the remotely controllable device using a first wireless communication protocol. The one or more processors may determine, from the distance and the direction, that the mobile device is pointing at the remotely controllable device. In response to the determination that the mobile device is in a handheld position, the determination that the mobile device is pointing at the remotely controllable device, or both, the one or more processors may monitor for a movement of the mobile device according to a prescribed gesture. The one or more processors may detect that the mobile device was moved according to the prescribed gesture while the mobile device was pointed at the remotely controllable device. The one or more processors may present, at a display of the mobile device and in response to the detection that the mobile device was moved according to the prescribed gesture, a first collection of selectable actions to control one or more operations of the remotely controllable device.

In some embodiments, in response to the determination that the mobile device is in a handheld position, the processor-readable instructions are further configured to cause the one or more processors to increase a scan rate of a wireless communication component associated with the first wireless communication protocol from a first frequency to a second frequency higher than the first frequency. In some embodiments, the processor-readable instructions are further configured to cause the one or more processors to detect, using a motion sensor, one or more movements of the mobile device, wherein the determination that the mobile device is in the handheld position is based at least in part on the one or more movements of the mobile device. In some embodiments, the processor-readable instructions are further configured to cause the one or more processors to receive a selection of a first action of the first collection of selectable actions corresponding to a first operation of the one or more operations. In response to receiving the selection of the first action, the one or more processors may transmit, using a second wireless communication protocol different from the first wireless communication protocol, a command to control the first operation of the remotely controllable device. In some embodiments, the first wireless communication protocol is an ultra-wideband communication protocol.

In some embodiments, a method for controlling a remotely controllable device is described. The method may comprise detecting, by a mobile device, a plurality of remotely controllable devices, wherein each remotely controllable device of the plurality is within a predefined threshold distance to other devices of the plurality, is within a predefined threshold angle of arrival at the mobile device, or both. The method may further comprise detecting, by the mobile device, a movement of the mobile device while the mobile device was pointing at the plurality of remotely controllable devices. The method may further comprise identifying, by the mobile device, the movement as a first prescribed gesture of a plurality of prescribed gestures, wherein each prescribed gesture of the plurality of prescribed gestures is associated with initiating control over one of the plurality of remotely controllable devices. The method may further comprise determining, by the mobile device, that the first prescribed gesture is associated with a first remotely controllable device of the plurality of remotely controllable devices. The method may further comprise initiating, by the mobile device, control over the first remotely controllable device by the mobile device in response to determining that the first prescribed gesture is associated with the first remotely controllable device.

In some embodiments, each prescribed gesture of the plurality of prescribed gestures is further associated with an application or function executable by one of the plurality of remotely controllable devices and the method further comprises determining that the first prescribed gesture is associated with a first application or function executable by the first remotely controllable device and presenting, at a display of the mobile device, a first collection of selectable actions to control one or more operations of the first application or function executable by the first remotely controllable device. In some embodiments, the first application or function is a media playback application and the first collection of selectable actions control one or more media playback operations. In some embodiments, the one or more media playback operations include one or more options to transfer playback from the mobile device to the first remotely controllable device, to transfer playback from the first remotely controllable device to the mobile device, or to initiate media playback on the first remotely controllable device.

In some embodiments, a method for controlling a remotely controllable device by voice is described. The method may comprise detecting, by a mobile device, that the mobile device was moved according to a prescribed gesture while the mobile device was pointed at the remotely controllable device. The method may further comprise determining that the prescribed gesture is associated with initiating voice assistant control over the remotely controllable device. The method may further comprise determining that the remotely controllable device is not voice assistant enabled. The method may further comprise identifying a voice assistant enabled device within a predefined threshold distance of the remotely controllable device. The method may further comprise capturing, by the voice assistant enabled device, audio data associated with a command configured to control an operation of the remotely controllable device. The method may further comprise controlling the operation of the remotely controllable device based on the captured audio data.

In some embodiments, determining that the remotely controllable device is not voice assistant enabled includes determining that the remotely controllable device does not include a microphone. In some embodiments, the voice assistant enabled device is identified by the remotely controllable device or the mobile device. In some embodiments, the mobile device is identified as the voice assistant enabled device.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an example smart home environment in accordance with some embodiments.

FIG. 2 is a block diagram illustrating an example network architecture that includes a smart home network in accordance with some embodiments.

FIG. 3 illustrates a network-level view of an extensible devices and services platform with which the smart home environment of FIG. 1 is integrated in accordance with some embodiments.

FIG. 4 illustrates an abstracted functional view of the extensible devices and services platform of FIG. 3, with reference to a processing engine as well as devices of the smart home environment, in accordance with some embodiments.

FIG. 5 is a representative operating environment in which a mobile device interacts with and controls remote devices in a smart home environment in accordance with some embodiments.

FIG. 6 illustrates an example network environment in which one or more access tiers may be used to limit control of remotely controllable devices in accordance with some embodiments.

FIG. 7 is a block diagram illustrating an example mobile device configured to selectively control remote devices in a smart home environment in accordance with some embodiments.

FIG. 8 illustrates an embodiment of a method for controlling a remotely controllable device by a mobile device.

FIG. 9 illustrates another embodiment of a method for controlling a remotely controllable device by a mobile device.

FIG. 10 illustrates an embodiment of a method for controlling music playback on a remotely controllable device by a mobile device.

FIG. 11 illustrates an embodiment of a method for controlling and transferring media interactions to and from a remotely controllable media device using a mobile device.

FIG. 12 & FIG. 13 illustrate an embodiment of a method for controlling and transferring music playback to and from a remotely controllable media device using a mobile device.

FIG. 14 illustrates an embodiment of a method for transferring communications to a remotely controllable device from a mobile device.

FIG. 15 illustrates an embodiment of a method for initiating voice command control over a remotely controllable device from a mobile device.

FIG. 16 illustrates another embodiment of a method for initiating voice command control over a remotely controllable device from a mobile device.

FIG. 17 illustrates an example of selecting one or more remote devices in a smart home environment for control by a mobile device in accordance with some embodiments.

FIG. 18 illustrates an example interface for controlling remote devices from a mobile device in accordance with some embodiments.

### DETAILED DESCRIPTION

As smart home devices and the methods for connecting and controlling such devices in a smart home environment continue to improve, the number and type of connected devices within a local environment will continue to expand. As the number of controllable devices found throughout a local environment expands, controlling such devices by navigating through corresponding applications or pages within applications to find relevant controls for the desired device can be time consuming, confusing, and frustrating for users. To alleviate some of these frustrations, additional wireless capabilities, such as ultra-wideband (UWB), can be used to identify devices for which control is likely desired, and/or automatically perform one or more device specific functions, based on the device's proximity to the mobile device from which control is desired.

However, relying on the two devices to be in relatively close proximity before initiating control over the smart device ameliorates many of the benefits that wirelessly connected smart devices were designed to provide in the first place. For example, if close proximity to a device is required, users could just as easily control the device manually if they are within arm's reach. Further, in cases that do not require the devices to be as close, other devices within the same proximity may make it difficult to determine which of the devices to begin controlling.

In contrast to initiating control based on close proximity, embodiments detailed herein focus on identifying the intended device for which control is desired based on a determination that the mobile device is pointing at the intended device, and subsequently initiating control over the device in response to detecting one or more physical gestures made with the mobile device while it is pointing at the intended device. Such arrangements as detailed herein can have significant benefits, such as improving the user experience and reducing processing and power consumption needs of sensors and communications components when they are not being used to detect, identify, and/or control remote devices.

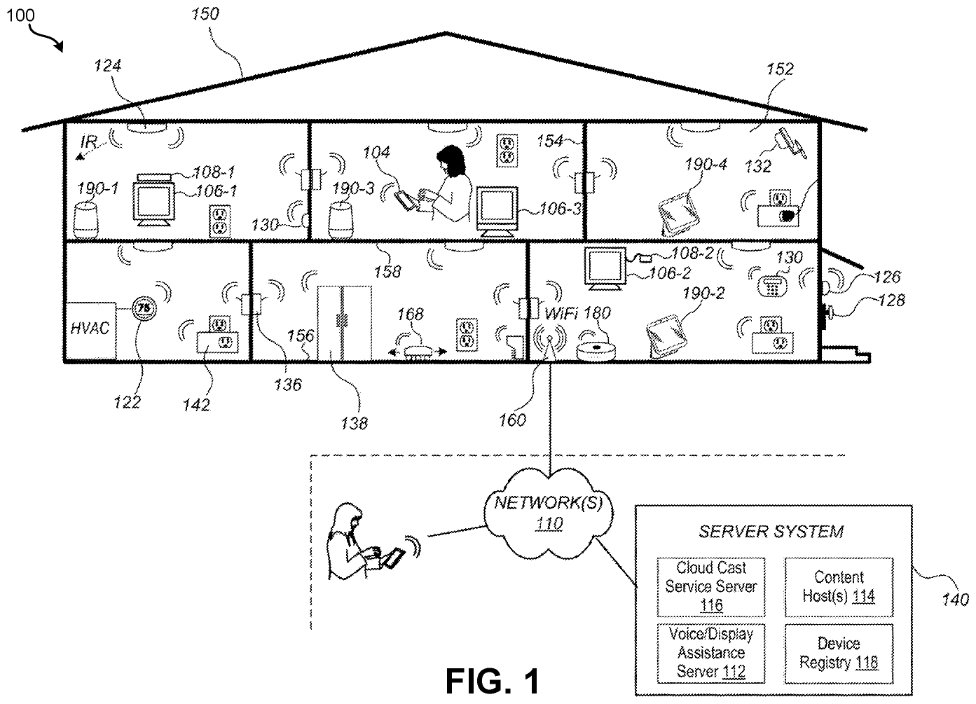

FIG. 1 illustrates an example smart home environment in accordance with some embodiments. The smart home environment 100 includes a structure 150 (e.g., a house, office building, garage, or mobile home) with various integrated devices (also referred to herein as “connected”, “smart”, or “remote” devices). It will be appreciated that smart devices may also be integrated into a smart home environment 100 that does not include an entire structure 150, such as an apartment, condominium, or office space. In some implementations, the smart devices include one or more of: personal client devices 104 (e.g., tablets, laptops or mobile phones, referred to additionally as mobile devices 104), display devices 106, media casting or streaming devices 108, thermostats 122, home protection devices 124 (e.g., smoke, fire and carbon dioxide detector), home security devices (e.g., motion detectors, window and door sensors and alarms), including connected doorbell/cameras 126, connected locksets 128, alarm systems 130 and cameras 132, connected wall switches transponders 136, connected appliances 138, WiFi communication devices 160 (e.g., hubs, routers, extenders), connected home cleaning devices 168 (e.g., vacuum or floor cleaner), smart home communication and control hubs 180, voice assistant devices and display assistant devices 190, and/or other smart home devices.

It is to be appreciated that the term “smart home environments” may refer to smart environments for homes such as a single-family house, but the scope of the present teachings is not so limited. The present teachings are also applicable, without limitation, to duplexes, townhomes, multi-unit apartment buildings, hotels, retail stores, office buildings, industrial buildings, yards, parks, and more generally any living space or workspace.

It is also to be appreciated that while the terms user, customer, installer, homeowner, occupant, guest, tenant, landlord, repair person, and the like may be used to refer to a person or persons acting in the context of some particular situations described herein, these references do not limit the scope of the present teachings with respect to the person or persons who are performing such actions. Thus, for example, the terms user, customer, purchaser, installer, subscriber, and homeowner may often refer to the same person in the case of a single-family residential dwelling who makes the purchasing decision, buys the unit, and installs and configures the unit, and is also one of the users of the unit. However, in other scenarios, such as a landlord-tenant environment, the customer may be the landlord with respect to purchasing the unit, the installer may be a local apartment supervisor, a first user may be the tenant, and a second user may again be the landlord with respect to remote control functionality. Importantly, while the identity of the person performing the action may be germane to a particular advantage provided by one or more of the implementations, such identity should not be construed in the descriptions that follow as necessarily limiting the scope of the present teachings to those particular individuals having those particular identities.

The depicted structure 150 includes a plurality of rooms 152, separated at least partly from each other via walls 154. The walls 154 may include interior walls or exterior walls. Each room may further include a floor 156 and a ceiling 158.

One or more media devices are disposed in the smart home environment 100 to provide users with access to media content that is stored locally or streamed from a remote content source (e.g., content host(s) 114). In some implementations, the media devices include displays 106, which directly output/display/play media content to an audience, and/or cast devices 108, which stream media content received over one or more networks to displays 106. Examples of the displays 106 include, but are not limited to, television (TV) display devices, music players and computer monitors. Examples of the cast devices 108 include, but are not limited to, medial streaming boxes, casting devices (e.g., GOOGLE CHROMECAST devices), set-top boxes (STBs), DVD players, TV boxes, and so forth.

In the example smart home environment 100, displays 106 are disposed in more than one location, and each display 106 is coupled to a respective cast device 108 or includes an embedded casting unit. The display 106-1 includes a TV display that is hard wired to a DVD player or a set top box 108-1. The display 106-3 includes a smart TV device that integrates an embedded casting unit to stream media content for display to its audience. The display 106-2 includes a regular TV display that is coupled to a TV box 108-1 (e.g., Google TV or Apple TV products), and such a TV box 108-2 streams media content received from a media content host server 114 and provides an access to the Internet for displaying Internet-based content on the media output device 106-2.

In addition to the media devices 106 and 108, one or more electronic devices 190 and are disposed in the smart home environment 100. Electronic devices 190 are display assistant devices and/or voice assistant devices. In some implementations, the display assistant device 190 is also a voice assistant device. The electronic devices 190 collect audio inputs for initiating various media play functions of the devices 190 and/or media devices 106 and 108. In some implementations, the devices 190 are configured to provide media content that is stored locally or streamed from a remote content source. In some implementations, the electronic devices 190 are voice-activated and are disposed in proximity to a media device, for example, in the same room with the cast devices 108 and the media output devices 106. Alternatively, in some implementations, a voice-activated display assistant device 190-1 is disposed in a room having one or more smart home devices but not any media device. Alternatively, in some implementations, a voice-activated electronic device 190 is disposed in a location having no networked electronic device. This allows for the devices 190 to communicate with the media devices and share content that is being displayed on one device to another device (e.g., from device 190-1 to device 190-2 and/or media devices 108).

The voice-activated electronic device 190 includes at least one microphone, a speaker, a processor and memory storing at least one program for execution by the processor. The speaker is configured to allow the electronic device 190 to deliver voice messages to a location where the electronic device 190 is located in the smart home environment 100, thereby broadcasting information related to a current media content being displayed, reporting a state of audio input processing, having a conversation with or giving instructions to a user of the electronic device 190. For instance, in some embodiments, in response to a user query the device provides audible information to the user through the speaker. As an alternative to the voice messages, visual signals could also be used to provide feedback to the user of the electronic device 190 concerning the state of audio input processing, such as a notification displayed on the device.

In accordance with some implementations, an electronic device 190 is a voice interface device that is network-connected to provide voice recognition functions with the aid of a server system 140. In some implementations, the server system 140 includes a cloud cast service server 116 and/or a voice/display assistance server 112. For example, in some implementations an electronic device 190 includes a smart speaker that provides music (e.g., audio for video content being displayed on the device 190 or on a display device 106) to a user and allows eyes-free and hands-free access to a voice assistant service (e.g., Google Assistant). Optionally, the electronic device 190 is a simple and low-cost voice interface device, e.g., a speaker device and a display assistant device (including a display screen having no touch detection capability).

In some implementations, the voice-activated electronic devices 190 integrates a display screen in addition to the microphones, speaker, processor and memory (e.g., 190-2 and 190-4), and are referred to as “display assistant devices.” The display screen is configured to provide additional visual information (e.g., media content, information pertaining to media content, etc.) in addition to audio information that can be broadcast via the speaker of the voice-activated electronic device 190. When a user is nearby and his or her line of sight is not obscured, the user may review the additional visual information directly on the display screen of the display assistant device. Optionally, the additional visual information provides feedback to the user of the electronic device 190 concerning the state of audio input processing. Optionally, the additional visual information is provided in response to the user's previous voice inputs (e.g., user queries), and may be related to the audio information broadcast by the speaker. In some implementations, the display screen of the voice-activated electronic devices 190 includes a touch display screen configured to detect touch inputs on its surface (e.g., instructions provided through the touch display screen). Alternatively, in some implementations, the display screen of the voice-activated electronic devices 190 is not a touch display screen, which is relatively expensive and can compromise the goal of offering the display assistant device 190 as a low-cost user interface solution.

When voice inputs from the electronic device 190 are used to control the electronic device 190 and/or media output devices 106 via the cast devices 108, the electronic device 190 effectively enables a new level of control of cast-enabled media devices independently of whether the electronic device 190 has its own display. In an example, the electronic device 190 includes a casual enjoyment speaker with far-field voice access and functions as a voice interface device for Google Assistant. The electronic device 190 could be disposed in any room in the smart home environment 100. When multiple electronic devices 190 are distributed in multiple rooms, they become audio receivers that are synchronized to provide voice inputs from all these rooms. For instance, a first electronic device 190 may receive a user instruction that is directed towards a second electronic device 190-2 (e.g., a user instruction of “OK Google, show this photo album on the kitchen device.”).

Specifically, in some implementations, an electronic device 190 includes a WiFi speaker with a microphone that is connected to a voice-activated personal assistant service (e.g., Google Assistant). A user could issue a media play request via the microphone of electronic device 190 and ask the personal assistant service to play media content on the electronic device 190 itself and/or on another connected media output device 106. For example, the user could issue a media play request by saying to the Wi-Fi speaker “OK Google, Play cat videos on my Living room TV.” The personal assistant service then fulfils the media play request by playing the requested media content on the requested device using a default or designated media application.

In some implementations, the display assistant device includes a display screen and one-or more built-in cameras (e.g., 190-4). The cameras are configured to capture images and/or videos, which are then transmitted (e.g., streamed) to a server system 140 for display on client devices(s).

A user could also make a voice request via the microphone of the electronic device 190 concerning the media content that has already been played and/or is being played on a display device. For instance, a user may instruct the device to provide information related to a current media content being displayed, such as ownership information or subject matter of the media content. In some implementations, closed captions of the currently displayed media content are initiated or deactivated on the display device by voice when there is no remote control or a second screen device is available to the user. Thus, the user can turn on the closed captions on a display device via an eyes-free and hands-free voice-activated electronic device 190 without involving any other device having a physical user interface, and such a voice-activated electronic device 190 satisfies federal accessibility requirements for users having hearing disability. In some implementations, a user wants to take a current media session with them as they move through the house. This requires the personal assistant service to transfer the current media session from a first cast device to a second cast device that is not directly connected to the first cast device or has no knowledge of the existence of the first cast device. Subsequent to the media content transfer, a second output device 106 coupled to the second cast device 108 continues to play the media content previously a first output device 106 coupled to the first cast device 108 from the exact point within a photo album or a video clip where play of the media content was forgone on the first output device 106.

In some implementations, the display assistant device 190 includes a display screen and one-or more built-in cameras. The cameras are configured to capture images and/or videos, which are then transmitted (e.g., streamed) to a server system 140 for display on client devices(s) (e.g., authorized client devices 104).

In some implementations, the voice-activated electronic devices 190, smart home devices could also be mounted on, integrated with and/or supported by a wall 154, floor 156 or ceiling 158 of the smart home environment 100 (which is also broadly called as a smart home environment in view of the existence of the smart home devices). The integrated smart home devices include intelligent, multi-sensing, network-connected devices that integrate seamlessly with each other in a smart home network and/or with a central server or a cloud-computing system to provide a variety of useful smart home functions. In some implementations, a smart home device is disposed at the same location of the smart home environment 100 as a cast device 108 and/or an output device 106, and therefore, is located in proximity to or with a known distance with respect to the cast device 108 and the output device 106.

In some implementations, the smart home devices in the smart home environment 100 includes, but are not limited to, one or more intelligent, multi-sensing, network-connected camera systems 132. In some embodiments, content that is captured by the camera systems 132 is displayed on the electronic devices 190 at a request of a user (e.g., a user instruction of “OK Google, Show the baby room monitor.”) and/or according to settings of the home environment 100 (e.g., a setting to display content captured by the camera systems during the evening or in response to detecting an intruder).

The smart home devices in the smart home environment 100 may include, but are not limited to, one or more intelligent, multi-sensing, network-connected thermostats 122, one or more intelligent, network-connected, multi-sensing hazard detectors 124, one or more intelligent, multi-sensing, network-connected entryway interface devices 126 and 128 (hereinafter referred to as “smart doorbells 126” and “smart door locks 128”), one or more intelligent, multi-sensing, network-connected alarm systems 130, one or more intelligent, multi-sensing, network-connected camera systems 132, and one or more intelligent, multi-sensing, network-connected wall switches 136. In some implementations, the smart home devices in the smart home environment 100 of FIG. 1 includes a plurality of intelligent, multi-sensing, network-connected appliances 138 (hereinafter referred to as “smart appliances 138”), such as refrigerators, stoves, ovens, televisions, washers, dryers, lights, stereos, intercom systems, garage-door openers, floor fans, ceiling fans, wall air conditioners, pool heaters, irrigation systems, security systems, space heaters, window AC units, motorized duct vents, and so forth.

The smart home devices in the smart home environment 100 may additionally or alternatively include one or more other occupancy sensors (e.g., touch screens, IR sensors, ambient light sensors and motion detectors). In some implementations, the smart home devices in the smart home environment 100 include radio-frequency identification (RFID) readers (e.g., in each room 152 or a portion thereof) that determine occupancy based on RFID tags located on or embedded in occupants. For example, RFID readers may be integrated into the smart hazard detectors.

In some implementations, in addition to containing sensing capabilities, devices 122, 124, 126, 128, 130, 132, 136, 138, and 190 (which are collectively referred to as “the smart home devices” or “the smart home devices 120”) are capable of data communications and information sharing with other smart home devices, a central server or cloud-computing system, and/or other devices (e.g., the client device 104, the cast devices 108 and the voice-activated electronic devices 190) that are network-connected. Similarly, each of the cast devices 108 and the voice-activated electronic devices 190 is also capable of data communications and information sharing with other cast devices 108, voice-activated electronic devices 190, smart home devices, a central server or cloud-computing system 140, and/or other devices (e.g., the client device 104) that are network-connected. Data communications may be carried out using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, MiWi, UWB, etc.) and/or any of a variety of custom or standard wired protocols (e.g., Ethernet, HomePlug, etc.), or any other suitable communication protocol, including communication protocols not yet developed as of the filing date of this document.

In some implementations, the cast devices 108, the electronic devices 190 and the smart home devices serve as wireless or wired repeaters. In some implementations, a first one of the cast devices 108 communicates with a second one of the cast devices 108 and the smart home devices 120 via a wireless router. The cast devices 108, the electronic devices 190 and the smart home devices 120 may further communicate with each other via a connection (e.g., network interface 160) to a network, such as the Internet 110. Through the Internet 110, the cast devices 108, the electronic devices 190 and the smart home devices 120 may communicate with a server system 140 (also called a central server system and/or a cloud-computing system herein). Optionally, the server system 140 may be associated with a manufacturer, support entity, or service provider associated with the cast devices 108 and the media content displayed to the user.

In general, any of the connected electronic devices described herein can be configured with a range of capabilities for interacting with users in the environment. For example, an electronic device can be configured with one or more microphones, one or more speakers and voice-interaction capabilities in which a user interacts with the device display assistant device via voice inputs received by the microphone and audible outputs played back by the speakers to present information to users. Similarly, an electronic device can be configured with buttons, switches and/or other touch-responsive sensors (such as a touch screen, touch panel, or capacitive or resistive touch sensors) to receive user inputs, and with haptic or other tactile feedback capabilities to provide tactile outputs to users. An electronic device can also be configured with visual output capabilities, such as a display panel and/or one or more indicator lights to output information to users visually. In addition, an electronic device can be configured with movement sensors that can detect movement of objects and people in proximity to the electronic device, such as a radar transceiver(s) or PIR detector(s).

Inputs received by any of these sensors can be processed by the electronic device and/or by a server communicatively coupled with the electronic device (e.g., the server system 140 of FIG. 1). In some implementations, the electronic device and/or the server processes and/or prepares a response to the user's input(s), which response is output by the electronic device via one or more of the electronic device's output capabilities. In some implementations, the electronic device outputs via one or more of the electronic device's output capabilities information that is not directly responsive to a user input, but which is transmitted to the electronic device by a second electronic device in the environment, or by a server communicatively coupled with the electronic device. This transmitted information can be of virtually any type that is displayable/playable by the output capabilities of the electronic device.

In some embodiments, the electronic devices described herein can be configured with a range of spatial awareness capabilities. For example, the electronic devices may use one or more techniques for determining the relative distances and/or directions from one device to the next. Such determinations may be facilitated using one or more wireless protocols, such as Bluetooth®, UWB, or other radar range, distance, and/or direction detection techniques. In some embodiments, the distance and/or direction between two or more devices may be used to control a particular device. For example, by determining that a client or mobile device 104 is pointing in the direction of a particular electronic device, one or more commands may be transmitted to the particular electronic device as opposed to another device within smart home environment 100.

The server system 140 provides data processing for monitoring and facilitating review of events (e.g., motion, audio, security, etc.) from data captured by the smart devices 120, such as video cameras 132, smart doorbells 126, and display assistant device 190-4. In some implementations, the server system 140 may include a voice/display assistance server 112 that processes audio inputs collected by voice-activated electronic devices 190, one or more content hosts 114 that provide the displayed media content, and a cloud cast service server 116 creating a virtual user domain based on distributed device terminals. The server system 140 also includes a device registry for keeping a record of the distributed device terminals in the virtual user environment. Examples of the distributed device terminals include, but are not limited to, the voice-activated electronic devices 190, cast devices 108, media output devices 106 and smart home devices 122-138. In some implementations, these distributed device terminals are linked to a user account (e.g., a Google user account) in the virtual user domain. In some implementations, each of these functionalities and content hosts is a distinct server within the server system 140. In some implementations, a subset of these functionalities is integrated within the server system 140.

In some implementations, the network interface 160 includes a conventional network device (e.g., a router). The smart home environment 100 of FIG. 1 further includes a hub device 180 that is communicatively coupled to the network(s) 110 directly or via the network interface 160. The hub device 180 is further communicatively coupled to one or more of the above intelligent, multi-sensing, network-connected devices (e.g., the cast devices 108, the electronic devices 190, the smart home devices and the client device 104). Each of these network-connected devices optionally communicates with the hub device 180 using one or more radio communication networks available at least in the smart home environment 100 (e.g., ZigBee, Z-Wave, Insteon, Bluetooth, Wi-Fi and other radio communication networks).

In some implementations, the hub device 180 and devices coupled with/to the hub device can be controlled and/or interacted with via an application running on a smart phone, household controller, laptop, tablet computer, game console or similar electronic device. In some implementations, a user of such controller application can view status of the hub device or coupled network-connected devices, configure the hub device to interoperate with devices newly introduced to the home network, commission new devices, and adjust or view settings of connected devices, etc.

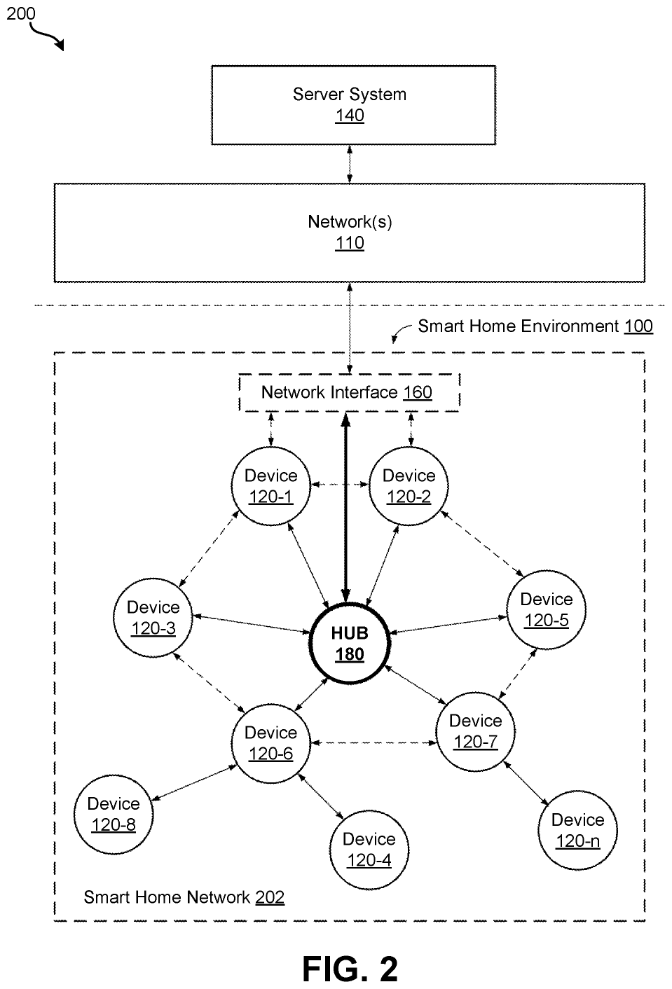

FIG. 2 is a block diagram illustrating an example network architecture 200 that includes a smart home network 202 in accordance with some embodiments. In some embodiments, the integrated devices of the smart home environment 100 include intelligent, multi-sensing, network-connected devices, herein referred to collectively as devices 120 or smart devices 120, that integrate seamlessly with each other in smart home network 202 and/or with a central server or a cloud-computing system (e.g., server system 140) to provide a variety of useful smart home functions.

In some embodiments, smart home devices 120 in smart home environment 100 combine with hub device 180 to create a mesh network in smart home network 202. In some embodiments, one or more smart devices 120 in smart home network 202 operate as a smart home controller. Additionally, or alternatively, hub device 180 operates as the smart home controller. In some embodiments, a smart home controller has more computing power than other smart devices. In some implementations, a smart home controller processes inputs (e.g., from smart devices 120, mobile devices 104, and/or server system 140) and sends commands (e.g., to smart devices 120 in smart home network 202) to control operation of smart home environment 100. In some embodiments, some of smart devices 120 in smart home network 202 (e.g., in the mesh network) are “spokesman” nodes (e.g., 120-1) and others are “low-powered” nodes (e.g., 120-8). Some of the smart devices in smart home environment 100 are battery powered, while others have a regular and reliable power source, such as by connecting to wiring (e.g., to 120 Volt line voltage wires) behind the walls 154 of the smart home environment. The smart devices that have a regular and reliable power source are referred to as “spokesman” nodes. These nodes are typically equipped with the capability of using a wireless protocol to facilitate bidirectional communication with a variety of other devices in smart home environment 100, as well as with server system 140. In some embodiments, one or more “spokesman” nodes operate as a smart home controller. On the other hand, the devices that are battery powered are the “low-power” nodes. These nodes tend to be smaller than spokesman nodes and typically only communicate using wireless protocols that require very little power, such as Zigbee, ZWave, 6LoWPAN, Thread, Bluetooth, etc.

In some embodiments, some low-power nodes are incapable of bidirectional communication. These low-power nodes send messages, but they are unable to “listen”. Thus, other devices in smart home environment 100, such as the spokesman nodes, cannot send information to these low-power nodes. In some embodiments, some low-power nodes are capable of only a limited bidirectional communication. For example, other devices are able to communicate with the low-power nodes only during a certain time period.

As described, in some embodiments, the smart devices serve as low-power and spokesman nodes to create a mesh network in smart home environment 100. In some embodiments, individual low-power nodes in the smart home environment regularly send out messages regarding what they are sensing, and the other low-powered nodes in the smart home environment—in addition to sending out their own messages—forward the messages, thereby causing the messages to travel from node to node (i.e., device to device) throughout smart home network 202. In some embodiments, the spokesman nodes in smart home network 202, which are able to communicate using a relatively high-power communication protocol, such as IEEE 802.11, are able to switch to a relatively low-power communication protocol, such as IEEE 802.15.4, to receive these messages, translate the messages to other communication protocols, and send the translated messages to other spokesman nodes and/or the server system 140 (using, e.g., the relatively high-power communication protocol). Thus, the low-powered nodes using low-power communication protocols are able to send and/or receive messages across the entire smart home network 202, as well as over the Internet 110 to server system 140. In some implementations, the mesh network enables server system 140 to regularly receive data from most or all of the smart devices in the home, make inferences based on the data, facilitate state synchronization across devices within and outside of smart home network 202, and send commands to one or more of the smart devices to perform tasks in the smart home environment.

As described, the spokesman nodes and some of the low-powered nodes are capable of “listening.” Accordingly, users, other devices, and/or the server system 140 may communicate control commands to the low-powered nodes. For example, a user may use the electronic device 104 (e.g., a smart phone) to send commands over the Internet to the server system 140, which then relays the commands to one or more spokesman nodes in smart home network 202. Additionally, or alternatively, electronic device 104 may transmit commands directly to spokesman nodes. The spokesman nodes may use a low-power protocol to communicate the commands to the low-power nodes throughout smart home network 202, as well as to other spokesman nodes that did not receive the commands directly from the server system 140 and/or electronic device 104.

Examples of low-power nodes include battery-powered versions of the smart hazard detectors, cameras 132, doorbells 126, and the like. These battery-powered smart devices are often located in an area without access to constant and reliable power and optionally include any number and type of sensors, such as image sensor(s), occupancy/motion sensors, ambient light sensors, ambient temperature sensors, humidity sensors, smoke/fire/heat sensors (e.g., thermal radiation sensors), carbon monoxide/dioxide sensors, and the like. Furthermore, battery-powered smart devices may send messages that correspond to each of the respective sensors to the other devices and/or the server system 140, such as by using the mesh network as described above.

Examples of spokesman nodes include line-powered smart doorbells 126, smart thermostats 122, smart wall switches 136, smart wall plugs 142, displays 106, streaming devices 108, devices 190, and/or hub device 180. These devices are located near, and connected to, a reliable power source, and therefore may include more power-consuming components, such as one or more communication chips capable of bidirectional communication in a variety of protocols, such as UWB.

As explained above with reference to FIG. 1, in some embodiments, smart home environment 100 includes a hub device 180 that is communicatively coupled to the network(s) 110 directly or via the network interface 160. The hub device 180 is further communicatively coupled to one or more of the smart devices using a radio communication network that is available at least in smart home environment 100. Communication protocols used by the radio communication network include, but are not limited to, ZigBee, Z-Wave, Insteon, EuOcean, Thread, OSIAN, Bluetooth Low Energy, UWB and the like. In some embodiments, the hub device 180 not only converts the data received from each smart device to meet the data format requirements of the network interface 160 or the network(s) 110, but also converts information received from the network interface 160 or the network(s) 110 to meet the data format requirements of the respective communication protocol associated with a targeted smart device. In some embodiments, in addition to data format conversion, hub device 180 further processes the data received from the smart devices or information received from network interface 160 or network(s) 110 preliminarily. For example, hub device 180 can integrate inputs from multiple sensors/connected devices (including sensors/devices of the same and/or different types), perform higher level processing on those inputs—e.g., to assess the overall environment and coordinate operation among the different sensors/devices—and/or provide instructions to the different devices based on the collection of inputs and programmed processing. It is also noted that in some embodiments, network interface 160 and hub device 180 are integrated to one network device. Functionality described herein is representative of particular embodiments of smart devices, control application(s) running on representative electronic device(s) (such as a smart phone), hub device(s) 180, and server(s) coupled to hub device(s) via the Internet or other Wide Area Network. All or a portion of this functionality and associated operations can be performed by any elements of the described system—for example, all or a portion of the functionality described herein as being performed by an implementation of the hub device can be performed, in different system implementations, in whole or in part on the server, one or more connected smart devices and/or the control application, or different combinations thereof.

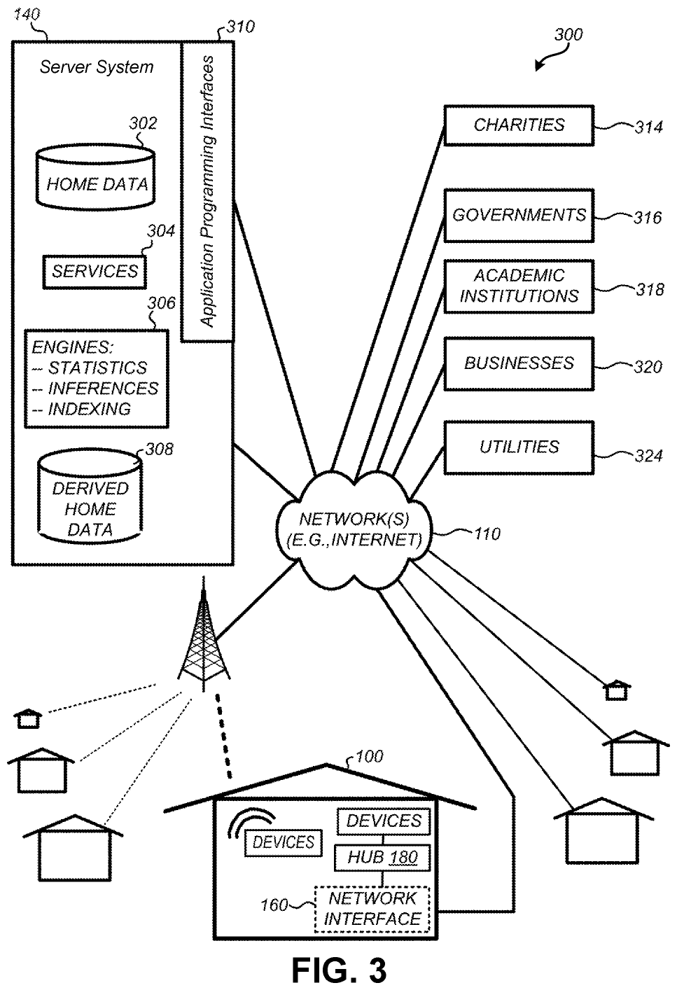

FIG. 3 illustrates a network-level view of an extensible devices and services platform with which the smart home environment of FIG. 1 is integrated in accordance with some embodiments. The extensible devices and services platform 300 includes server system 140. Each of the intelligent, network-connected devices described with reference to FIG. 1 (identified simply as “devices” in FIGS. 2-5) may communicate with the smart home provider server system 140. For example, a connection to the Internet 110 may be established either directly (for example, using 3G/4G connectivity to a wireless carrier), or through a network interface 160 (e.g., a router, switch, gateway, hub device, or an intelligent, dedicated whole-home controller node), or through any combination thereof.

In some implementations, the devices and services platform 300 communicates with and collects data from the smart devices of the smart home environment 100. In addition, in some implementations, the devices and services platform 300 communicates with and collects data from a plurality of smart home environments across the world. For example, the smart home provider server system 140 collects home data 302 from the devices of one or more smart home environments 100, where the devices may routinely transmit home data or may transmit home data in specific instances (e.g., when a device queries the home data 302). Example collected home data 302 includes, without limitation, power consumption data, blackbody radiation data, occupancy data, HVAC settings and usage data, carbon monoxide levels data, carbon dioxide levels data, volatile organic compounds levels data, sleeping schedule data, cooking schedule data, inside and outside temperature humidity data, television viewership data, inside and outside noise level data, pressure data, video data, etc.

In some embodiments, the smart home provider server system 140 provides one or more services 304 to smart homes and/or third parties. Example services 304 include, without limitation, software updates, customer support, sensor data collection/logging, remote access, remote or distributed control, and/or use suggestions (e.g., based on collected home data 302) to improve performance, reduce utility cost, increase safety, etc. In some embodiments, data associated with the services 304 is stored at the smart home provider server system 140, and the smart home provider server system 140 retrieves and transmits the data at appropriate times (e.g., at regular intervals, upon receiving a request from a user, etc.).

In some embodiments, the extensible devices and services platform 300 includes a processing engine 306, which may be concentrated at a single server or distributed among several different computing entities without limitation. In some implementations, the processing engine 306 includes engines configured to receive data from the devices of smart home environments 100 (e.g., via the Internet 1110 and/or a network interface 160), to index the data, to analyze the data and/or to generate statistics based on the analysis or as part of the analysis. In some implementations, the analyzed data is stored as derived home data 308.

Results of the analysis or statistics may thereafter be transmitted back to the device that provided home data used to derive the results, to other devices, to a server providing a webpage to a user of the device, or to other non-smart device entities. In some implementations, usage statistics, usage statistics relative to use of other devices, usage patterns, and/or statistics summarizing sensor readings are generated by the processing engine 306 and transmitted. The results or statistics may be provided via the Internet 110. In this manner, the processing engine 306 may be configured and programmed to derive a variety of useful information from the home data 302. A single server may include one or more processing engines.

The derived home data 308 may be used at different granularities for a variety of useful purposes, ranging from explicit programmed control of the devices on a per-home, per-neighborhood, or per-region basis (for example, demand-response programs for electrical utilities), to the generation of inferential abstractions that may assist on a per-home basis (for example, an inference may be drawn that the homeowner has left for vacation and so security detection equipment may be put on heightened sensitivity), to the generation of statistics and associated inferential abstractions that may be used for government or charitable purposes. For example, processing engine 306 may generate statistics about device usage across a population of devices and send the statistics to device users, service providers or other entities (e.g., entities that have requested the statistics and/or entities that have provided monetary compensation for the statistics).

In some implementations, to encourage innovation and research and to increase products and services available to users, the devices and services platform 300 exposes a range of application programming interfaces (APIs) 310 to third parties, such as charities 314, governmental entities 316 (e.g., the Food and Drug Administration or the Environmental Protection Agency), academic institutions 318 (e.g., university researchers), businesses 320 (e.g., providing device warranties or service to related equipment, targeting advertisements based on home data), utility companies 324, and other third parties. The APIs 310 are coupled to and permit third-party systems to communicate with the smart home provider server system 164, including the services 304, the processing engine 306, the home data 302, and the derived home data 308. In some implementations, the APIs 310 allow applications executed by the third parties to initiate specific data processing tasks that are executed by the smart home provider server system 140, as well as to receive dynamic updates to the home data 302 and the derived home data 308.

For example, third parties may develop programs and/or applications (e.g., web applications or mobile applications) that integrate with the smart home provider server system 140 to provide services and information to users. Such programs and applications may be, for example, designed to help users reduce energy consumption, to preemptively service faulty equipment, to prepare for high service demands, to track past service performance, etc., and/or to perform other beneficial functions or tasks.

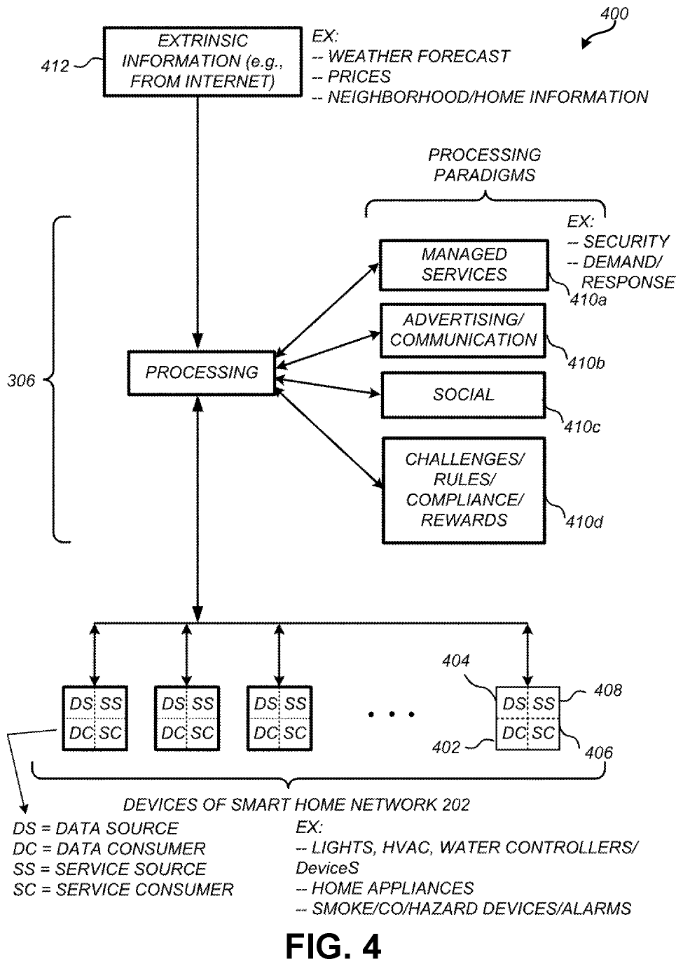

FIG. 4 illustrates an abstracted functional view 400 of the extensible devices and services platform 300 of FIG. 3, with reference to a processing engine 306 as well as devices of the smart home environment, in accordance with some embodiments. Even though devices situated in smart home environments will have a wide variety of different individual capabilities and limitations, the devices may be thought of as sharing common characteristics in that each device is a data consumer 402 (DC), a data source 404 (DS), a services consumer 406 (SC), and a services source 408 (SS). Advantageously, in addition to providing control information used by the devices to achieve their local and immediate objectives, the extensible devices and services platform 300 may also be configured to use the large amount of data that is generated by these devices. In addition to enhancing or optimizing the actual operation of the devices themselves with respect to their immediate functions, the extensible devices and services platform 300 may be directed to “repurpose” that data in a variety of automated, extensible, flexible, and/or scalable ways to achieve a variety of useful objectives. These objectives may be predefined or adaptively identified based on, e.g., usage patterns, device efficiency, and/or user input (e.g., requesting specific functionality).

FIG. 4 shows processing engine 306 as including a number of processing paradigms 410. In some embodiments, processing engine 306 includes a managed services paradigm 410a that monitors and manages primary or secondary device functions. The device functions may include ensuring proper operation of a device given user inputs, estimating that (e.g., and responding to an instance in which) an intruder is or is attempting to be in a dwelling, detecting a failure of equipment coupled to the device (e.g., a light bulb having burned out), implementing or otherwise responding to energy demand response events, providing a heat-source alert, and/or alerting a user of a current or predicted future event or characteristic. In some embodiments, processing engine 306 includes an advertising/communication paradigm 410b that estimates characteristics (e.g., demographic information), desires and/or products of interest of a user based on device usage. Services, promotions, products or upgrades may then be offered or automatically provided to the user. In some embodiments, processing engine 306 includes a social paradigm 410c that uses information from a social network, provides information to a social network (for example, based on device usage), and/or processes data associated with user and/or device interactions with the social network platform. For example, a user's status as reported to their trusted contacts on the social network may be updated to indicate when the user is home based on light detection, security system inactivation or device usage detectors. As another example, a user may be able to share device-usage statistics with other users. In yet another example, a user may share HVAC settings that result in low power bills and other users may download the HVAC settings to their smart thermostat 122 to reduce their power bills.

In some embodiments, processing engine 306 includes a challenges, rules, compliance, and/or rewards paradigm 410d that informs a user of challenges, competitions, rules, compliance regulations and/or rewards and/or that uses operation data to determine whether a challenge has been met, a rule or regulation has been complied with and/or a reward has been earned. The challenges, rules, and/or regulations may relate to efforts to conserve energy, to live safely (e.g., reducing the occurrence of heat-source alerts) (e.g., reducing exposure to toxins or carcinogens), to conserve money and/or equipment life, to improve health, etc. For example, one challenge may involve participants turning down their thermostat by one degree for one week. Those participants that successfully complete the challenge are rewarded, such as with coupons, virtual currency, status, etc. Regarding compliance, an example involves a rental-property owner making a rule that no renters are permitted to access certain owner's rooms. The devices in the room having occupancy sensors may send updates to the owner when the room is accessed.

In some embodiments, processing engine 306 integrates or otherwise uses extrinsic information 412 from extrinsic sources to improve the functioning of one or more processing paradigms. Extrinsic information 412 may be used to interpret data received from a device, to determine a characteristic of the environment near the device (e.g., outside a structure that the device is enclosed in), to determine services or products available to the user, to identify a social network or social-network information, to determine contact information of entities (e.g., public-service entities such as an emergency-response team, the police or a hospital) near the device, to identify statistical or environmental conditions, trends or other information associated with a home or neighborhood, and so forth.

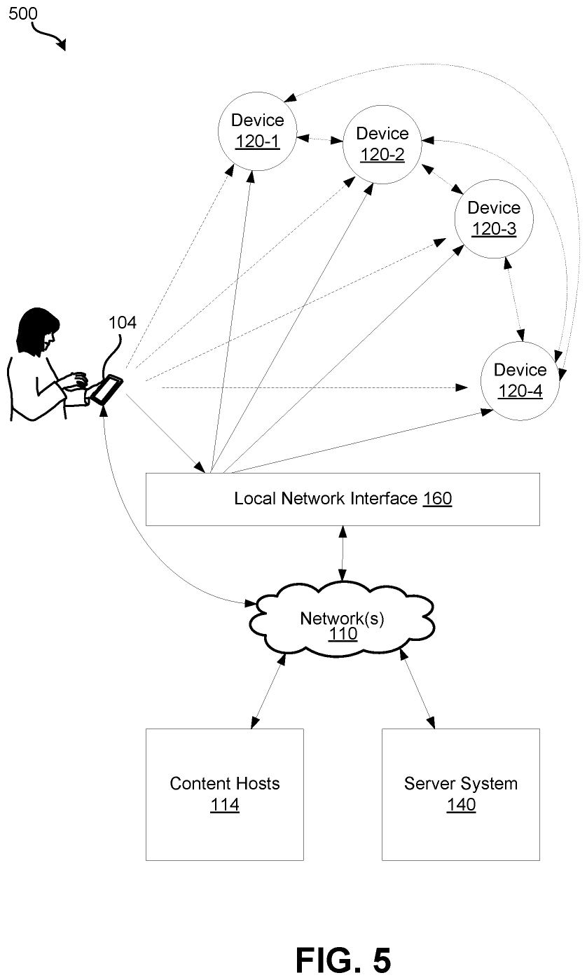

FIG. 5 is a representative operating environment 500 in which a mobile device 104 interacts with and controls remote devices 120 in a smart home environment in accordance with some embodiments. As illustrated, mobile device 104 and devices 120 may be a part of a smart home environment, such as smart home environment 100 described above. For example, mobile device 104 may communicate with devices 120 via local network interface 160. At the edge of the smart home environment, local network interface 160 may interface with wider area network(s) 110, such as the internet in order to transmit/receive data between mobile device 104, devices 120, and one or more server systems, such as server system 140.

As further illustrated in FIG. 5, mobile device 104 may be configured to communicate directly with network(s) 110, such as via one or more cellular networks. Additionally, or alternatively, local network interface 160 may be an interface to a local mesh network, such as provided by a hub device, while network(s) 110 may represent a Wi-Fi network. As such, devices 120 may be configured for device-to-device communications amongst each other and may receive communications and/or commands from other devices transmitted initially to network(s) 110 for distribution by local network interface 160. In some embodiments, mobile device 104 is configured to communicate directly with devices 120 via one or more wireless protocols, such as Bluetooth®, UWB, Matter, and the like. The communications between mobile device 104 and devices 120 may include commands to control an operation of the remote device.

Additional examples of the one or more networks 110 include local area networks (LAN) and wide area networks (WAN) such as the Internet. The one or more networks 110 are implemented using any known network protocol, including various wired or wireless protocols, such as Ethernet, Universal Serial Bus (USB), FIREWIRE, Long Term Evolution (LTE), Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol.

In some embodiments, mobile device 104 and/or devices 120 are configured to obtain media content or Internet content from one or more content hosts 114 or server system 140 for presentation by the receiving device or another device selected for content presentation. For example, mobile device 104 and/or devices 120 may stream media content such as music, podcasts, audiobooks, movies, television, internet videos and the like. Additionally, or alternatively, mobile device 104 and/or devices 120 may be configured to facilitate simultaneous bi-directional communications including voice and/or video calling between two or more participants.

Media content and/or communications may be cast, or otherwise transferred, between mobile device 104 and devices 120. For example, mobile device 104 may begin streaming music content from content hosts 114 and thereafter cause the streaming to be transferred to one or more of devices 120. Additionally, or alternatively, media playback may be initiated by a first device on a second device. For example, mobile device 104 may transmit a command to one or more of devices 120 to begin streaming content from content hosts 114.

While described above as being configured for media playback, other functionalities are similarly applicable. For example, one or more of devices 120 may be a smart thermostat configured to control one or more operations of an HVAC system in response to commands received from mobile device 104 and/or server system 140. As another example, one or more of devices 120 may be a smart camera configured to stream real-time, or semi-real-time imagery captured by the smart camera to mobile device 104 and/or server system 140 in response to one or more commands received from mobile device 104. In yet another example, one or more of devices 120 may include a smart speaker or a display assistant device configured to record audio for speech recognition in response to one or more commands received from mobile device 104.

Server system 140 may be implemented on one or more standalone data processing apparatuses or a distributed network of computers. In some embodiments, server system 140 also employs various virtual devices and/or services of third-party service providers (e.g., third-party cloud service providers) to provide the underlying computing resources and/or infrastructure resources of the server system 140. In some embodiments, server system 140 includes, but is not limited to, a server computer, a cloud server, a distributed cloud computing system, a handheld computer, a tablet computer, a laptop computer, a desktop computer, or a combination of any two or more of these data processing devices or other data processing devices.

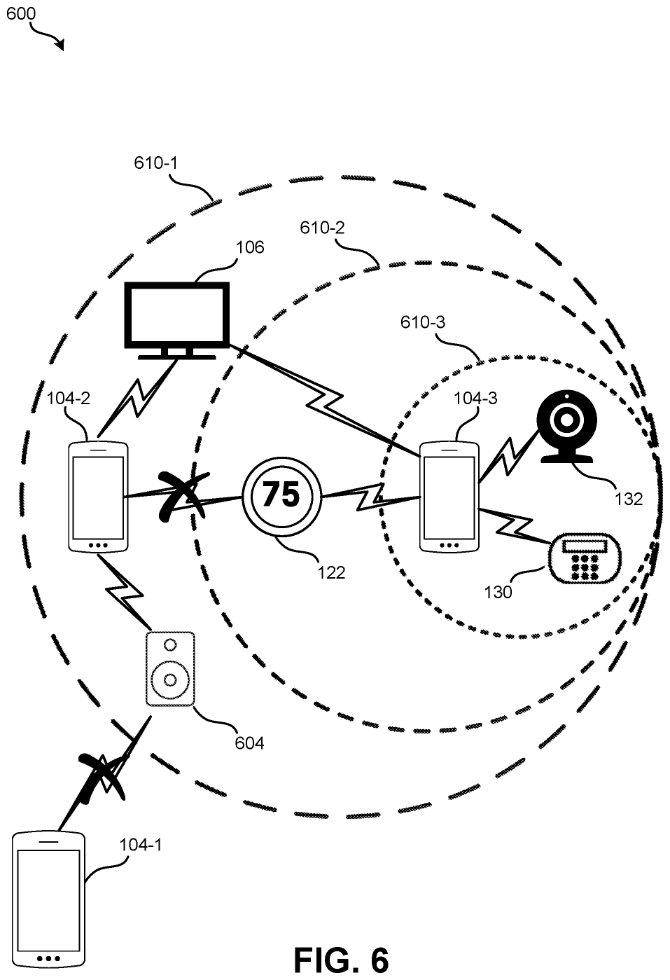

FIG. 6 illustrates an example network environment 600 in which one or more access tiers may be used to limit control of remotely controllable devices. Network environment 600 can include one or more mobile devices 104 and one or more remotely controllable device, such as smart speaker 604, display 106, smart thermostat 122, smart camera 132, and alarm systems 130. Network environment 600 may include one or more networks configured to enable communication between and among mobile devices 104 and the one or more remotely controllable devices. For example, network environment 600 may include a Wi-Fi and/or a one or more mesh networks, as described above in reference to network 110.

Network environment 600 can include one or more access tiers 610. Access tiers 610 may manage whether a particular mobile device may detect and/or control a remotely controllable devices assigned to a particular access tier. The number and type of access tiers 610 may be managed by one or more administrative accounts associated with network environment 600. For example, an administrative account associated with a user of mobile device 104-3 (e.g., associated with a homeowner or building manager), may create, modify, and/or delete first access tier 610-1, second access tier 610-2, and third access tier 610-3 with varying access and/or device control restrictions associated with each respective access tier.

Once access tiers 610 are created, remotely controllable devices may be assigned to a particular access tier. For example, as illustrated, smart speaker 604 and display 106 may be assigned to first access tier 610-1, smart thermostat 122 may be assigned to access tier 610-2, and smart camera 132 and alarm systems 130 may be assigned to access tier 610-3. Similarly, as mobile devices 104 join network environment 600, they may be assigned to a respective access tier. For example, as further illustrated, mobile device 104-2 may be assigned to access tier 610-1 and mobile device 104-3 may be assigned to access tier 610-3. Mobile devices that have joined network environment 600 may initially receive a default access tier assignment. Alternatively, mobile devices that have joined network environment 600 may initially be excluded from all access tiers until they have actively been added to an access tier. For example, as illustrated, mobile device 104-1 may not be assigned to any of access tiers 610.

Access tiers 610 may overlap with each other, in that remotely controllable devices assigned to a particular access tier may be controlled by mobile devices assigned to another access tier. For example, as illustrated, third access tier 610-3 may overlap with second access tier 610-2, which may in turn overlap with first access tier 610-1. As a result, mobile devices, such as mobile device 104-3, assigned to third access tier 610-3 may be approved to control remotely controllable devices in second access tier 610-2 (e.g., smart thermostat 122) and first access tier 610-1 (e.g., smart speaker 604 and display 106) in addition to being approved control remotely controllable devices in third access tier 610-3 (e.g., smart camera 132 and alarm systems 130).

Overlapping controls between access tiers 610 may flow in a single direction, such as from more restrictive access tiers to less restrictive access tiers. For example, third access tier 610-3 may be a most restrictive access tier such that mobile device 104-3 may control remotely controllable devices in lessor restrictive access tiers (e.g., second access tier 610-2 and first access tier 610-1) while mobile device 104-2 in first access tier 610-1 may be limited to controlling only those remotely controllable devices in first access tier 610-1 (e.g., smart speaker 604 and display 106). This may be the case when, for example, an administrative user (e.g., a homeowner) wishes to restrict full device access to a limited number of other users (e.g., co-owners), allow access to another subset of devices to a broader group of users (e.g., children or roommates), and grant access to yet another subset of devices to guests of network environment 600.

While described above as restricting access to control particular remotely controllable devices, access tiers 610 may additionally, or alternatively, be used to control access to individual operations of particular remotely controlled devices. For example, a subset of remotely controllable operations associated with display 106 may be accessible to mobile device 104-2, while additional remotely controllable operations associated with display 106 may only be accessible to mobile device 104-3. In operation, this may function similar to parental controls.

In some embodiments, mobile devices 104 are added to access tiers 610 on a device-by-device basis. For example, when a user of device 104-1 wishes to be a part of access tier 610-1, an administrative user (e.g., associated with mobile device 104-3) may grant individual access to mobile device 104-1. Additionally, or alternatively, mobile devices 104 may be added to access tiers 610 on an associated user account basis. For example, after granting access to a user account associated with mobile device 104-1, subsequent mobile devices associated with the same user account may be automatically granted access to access tier 610-1.

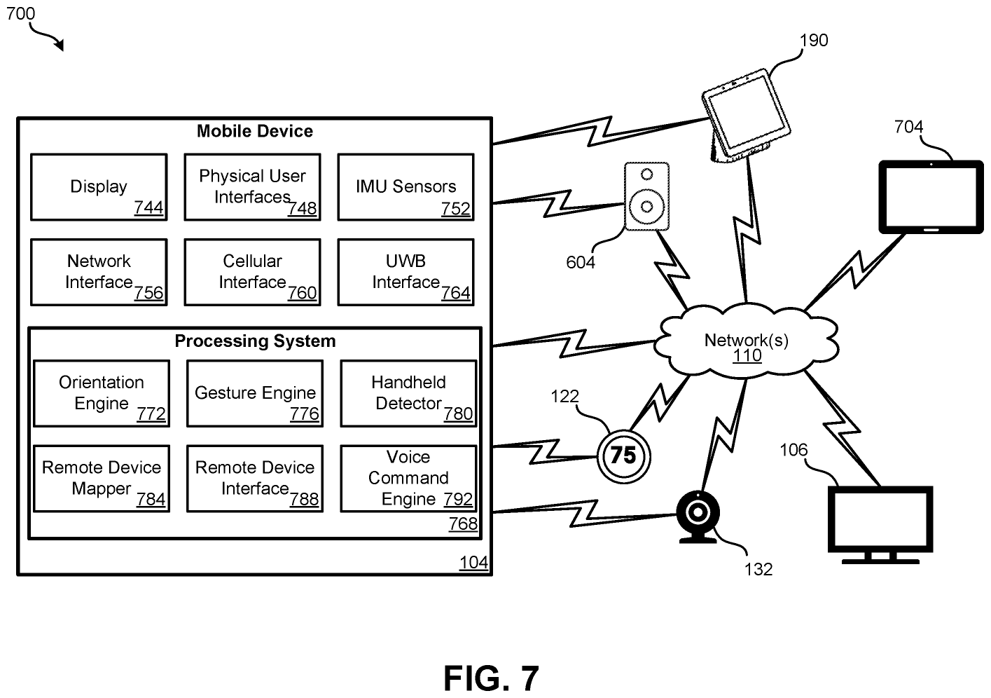

FIG. 7 is a block diagram illustrating an example mobile device 104 configured to selectively control remote devices in a smart home environment 700 in accordance with some embodiments. Smart home environment 700 may be the same, or include similar features, as smart home environment 100 described above. For example, smart home environment 700 can include one or more electronic devices such as smart thermostat 122, smart camera 132, display 106, smart speaker 604, display assistant device 190, personal computing device 704, and mobile device 104. In some embodiments, one or more components of smart home environment 700 are communicatively connected to other components of smart home environment 700 via network 110. Additionally, or alternatively, one or more components of smart home environment 700 may be configured to communicate with other components of smart home environment 700 using one or more device-to-device communication protocols, as explained further below.

Smart home environment 700 may form all, or a part, of the physical and/or digital environment in which the operation of one or more devices can by controlled remotely. For example, one or more components of smart home environment 700 may transmit and receive data over network 110. Data received by the components of smart home environment 700 may include operating instructions received from another component of smart home environment 700. Additionally, or alternatively, components of smart home environment 700 may receive data from one or more internet-based, or cloud-based, server systems. For example, smart speaker 604 may receive audio data from one or more music streaming services for playback thereon. Components of smart home environment 700 may transmit data associated with operating in accordance with one or more operating instructions to other components of smart home environment 700 and/or to one or more remote server systems. For example, video and/or audio data recorded by smart camera 132 may be transmitted to display 106 for display thereon. As another example, smart thermostat 122 may transmit usage statistics, such as one or more setpoint temperatures recorded for previous time period, to a cloud-based server system for statistical analysis to improve future operations of smart thermostat 122.

Smart home environment 700 may be located in and/or around a physical structure, such as a house, apartment, condominium, multi-unit housing structure, office building, warehouse, and the like. For example, smart thermostat 122, display 106, and smart speaker 604 may be installed within an interior of an apartment. As another example, smart camera 132 may be installed on the exterior perimeter of a house, office building, warehouse, and the like. Components of smart home environment 700 may be installed at a permanent or semi-permanent location. For example, smart thermostat 122 and smart camera 132 may each be affixed to a surface, such as an interior or exterior wall, and/or physically connected to one or more infrastructure components of the greater physical structure, such as electrical wiring connecting smart thermostat 122 to a furnace. Additionally, or alternatively, components of smart home environment 700 may be portable. For example, smart speaker 604 and personal computing device 704 may each be carried from room to room.

Smart home environment 700 may include fewer or more types of connected devices than illustrated. For example, smart home environment 700 may include network connected door locks, lighting, garage doors, appliances (e.g., washers, dryers, refrigerators, etc.), hazard detectors (e.g., smoke and carbon monoxide sensors), irrigation systems, doorbells, and the like. Additional components may be added to, or removed from, smart home environment 700 based on connection to a network, such as network 110. Additionally, or alternatively, the addition or subtraction of components to or from smart home environment 700 may be managed by one or more devices within smart home environment 700, such as display assistant device 190 and/or a hub device, as described above.

Display assistant device 190 may be a computerized device that can communicate with one or more remote server systems via network 110. Display assistant device 190 may also be configured to communicate, via network 110 and/or directly, with any of smart thermostat 122, smart camera 132, display 106, smart speaker 604, personal computing device 704, and mobile device 104. For example, display assistant device 190 may be configured to send and receive communications via any of a variety of custom or standard wireless protocols (Wi-Fi, ZigBee®, 6LoWPAN, Thread®, Bluetooth®, BLE®, HomeKit Accessory Protocol (HAP)®, Weave®, Matter, etc.) and/or any of a variety of custom or standard wired protocols (CAT6 Ethernet, HomePlug®, etc.). In some embodiments, display assistant device 190 can serve as an edge router that translates communications between a mesh network and a wireless network, such as a Wi-Fi network. For example, one or more components, such as smart thermostat 122, smart camera 132, display 106, and/or smart speaker 604, may form a mesh network and transmit data to display assistant device 190 for relay to a remote server system. Additionally, or alternatively, display assistant device 190 may receive data from mobile device 104 and/or personal computing device 704 (e.g., over network 110) for relay to one or more components of the mesh network.

Network 110 can include one or more wireless networks, wired networks, public networks, private networks, and/or mesh networks. A home wireless local area network (e.g., a Wi-Fi network) may be part of network 110. Network 110 can include the Internet. Network 110 can include a mesh network, such as Thread, which may include one or more other smart home devices, and may be used to enable smart thermostat 122, smart camera 132, display 106, and/or smart speaker 604 to communicate with another network, such as a Wi-Fi network (e.g., as described above in reference to display assistant device 190).

Mobile device 104 may be a smartphone, tablet computer, laptop computer, gaming device, or some other form of computerized device that can communicate directly, or indirectly via network 110, with any of smart thermostat 122, smart camera 132, display 106, smart speaker 604, display assistant device 190, and personal computing device 704. Personal computing device 704 may be a tablet computer, laptop computer, desktop computer, or other similar computerized device capable of communicating directly, or indirectly, with other components of smart home environment 700. Mobile device 104 and personal computing device 704 may be further configured to communicate with other devices, services, systems, and the like via one or more networks, such as the internet, a cellular network, and the like.

Mobile device 104 and personal computing device 704 may receive user interactions with one or more applications executed thereon via one or more user interfaces. For example, as described further below, mobile device 104 may execute one or more applications corresponding to one or more other components of smart home environment 700. Such applications may enable a user to control one or more operations of the other components of smart home environment 700. For example, a smart home application executing on mobile device 104 may present one or more thermostat control graphical user interfaces (GUIs) associated with smart thermostat 122. Additionally, or alternatively, such a smart home application may provide one or more GUIs configured to display current, or historical, video data captured by smart camera 132.

Mobile device 104 may include one or more hardware and/or firmware components, such as display 744, physical user interfaces 748, inertial measurement unit (IMU) sensors 752, network interface 756, cellular interface 760, ultra-wideband (UWB) interface 764, and processing system 768. In some embodiments, personal computing device 704 includes some or all of the same hardware and/or firmware components as mobile device 104.

Display 744 can be an integrated screen on mobile device 104. For example, display 744 may be a color LED, OLED, AMOLED, or LCD display panel. Additionally, or alternatively, display 744 may be a touch screen and may thus be used to receive user input. Physical user interfaces 748 may include one or more buttons, scroll wheels, keyboards, joysticks, and the like. While not illustrated, mobile device 104 may include one or more of audio outputs such as a speaker, wired audio output interface, or wireless audio output interface.

IMU sensors 752 can include one or more accelerometers, gyroscopes, motion sensors, tilt sensors, inclinometers, angular velocity sensors, gravity sensors, magnetometers, compasses, and the like. IMU sensors 752 may be configured to detect movements of mobile device 104. For example, as a user carries and/or operates mobile device 104, IMU sensors 752 may detect the associated movements from one or more sensor measurements. In some embodiments, IMU sensors 752 may output the movements as raw sensor measurements to processing system 768 for additional analysis, such as by orientation engine 772. Additionally, or alternatively, IMU sensors 752 may process the sensor measurements to classify the measurements as specific types of movement, such as those associated with walking, holding a phone up to an ear of a user, placing the device on a stationary surface, and the like. In some embodiments, IMU sensors 752 collect and/or analyze motion measurements at a default baseline frequency, such as 1 Hz, 5 Hz, 20 Hz, or more frequently. In response to one or more stimuli, IMU sensors 752 may begin collecting and/or analyzing motion measurements more or less frequently. For example, in response to detecting motion associated with handheld use, IMU sensors 752 may begin collecting motion data at a higher frequency as compared with a default, or baseline, data collection frequency. As another example, IMU sensors 752 may decrease a collection frequency in response to detecting motion, or a lack of motion, often associated with placement on a stationary surface.

Network interface 756 can allow mobile device 104 to communicate with one or more types of wireless networks, such as IEEE 802.11 or Wi-Fi networks. Network interface 756 may primarily be used for communication with a local access point (AP) such as a wireless network router. Network interface 756 can allow for access to network 110, which can include the Internet. Additional or alternative network interfaces may also be present. For example, mobile device 104 may be able to communicate directly with other components of smart home environment 700 using Bluetooth®. Cellular interface 760 may allow mobile device 104 to communicate with one or more cellular networks.

UWB interface 764 can separately receive and process UWB messages via one or more UWB antennas of mobile device 104. In some embodiments, a separate UWB interface is present for each UWB antenna. UWB interface 764 can receive raw RF signals via the one or more UWB antennas and process such RF signals into digital data to be passed to processing system 768. In some embodiments, UWB interface 764 can be incorporated as part of processing system 768.

In some embodiments, network interface 756 and/or UWB interface 764 may scan for other devices in the vicinity of mobile device 104. For example, after connecting to network 110, network interface 756 may broadcast a request for device identification from other devices connected to network 110. Similarly, UWB interface 764 may periodically broadcast a similar request for identification by other UWB enabled devices. In response, network interface 756 and/or UWB interface 764 may receive one or more identifications associated with devices connected to network 110 and/or UWB enabled. In some embodiments, the request for identification is configured to reduce the number of responses to those devices controllable by mobile device 104. Additionally, or alternatively, the request may be configured to elicit responses from devices acting as an edge router, such as display assistant device 190, that translates communications between a mesh network of controllable devices and a broader network.

In some embodiments, network interface 756 and/or UWB interface 764 scan for controllable devices within the vicinity of mobile device 104 according to a default, or baseline, scanning frequency. Such a default, or baseline, scanning frequency may be configured to reduce power consumption of the hardware components of mobile device 104. In response to a stimulus, the scanning frequency may be increased to improve the accuracy and/or precision of one or more functions of mobile device 104. For example, as described further below, the scanning frequency of UWB interface 764 may be increased from a default scanning frequency to a higher ranging/direction scanning frequency to help determine a distance and direction to a particular device.

Processing system 768 may include one or more special-purpose or general-purpose processors. Such special-purpose processors may include processors that are specifically designed to perform the functions of the components detailed herein. Such special-purpose processors may be ASICs or FPGAs which are general-purpose components that are physically and electrically configured to perform the functions detailed herein. Such general-purpose processors may execute special-purpose software that is stored using one or more non-transitory processor-readable mediums, such as RAM, flash memory, an HDD, or SSD. One or more non-transitory processor-readable mediums can be incorporated as part of processing system 768.

Processing system 768 may configure mobile device 104 to execute one or more software or application modules, including orientation engine 772, gesture engine 776, handheld detector 780, remote device mapper 784, remote device interface 788, and voice command engine 792. As described above, such application modules may be stored on mobile device 104 using one or more non-transitory processor-readable mediums.

Orientation engine 772 may be configured to determine an orientation, an attitude, and/or a posture for mobile device 104. Orientation engine 772 may utilize sensor measurements collected by one or more motion sensors, such as IMU sensors 752, of mobile device 104 to determine the real-world orientation of mobile device 104. Additionally, or alternatively, orientation engine 772 may utilize measurements collected and/or calculated by UWB interface 764 to determine a relative orientation of mobile device 104 with respect to another UWB enabled device.

In some embodiments, orientation engine 772 is configured to determine whether mobile device 104 is oriented in a particular orientation. For example, orientation engine 772 can determine whether mobile device 104 is oriented in a direction in which a vertical or horizontal axis of mobile device 104 is parallel with, or perpendicular to, earth's gravity, or within a predefined threshold deviation from being parallel with, or perpendicular to, earth's gravity. In some embodiments, orientation engine 772 determines the orientation of mobile device 104 relative to a frame of reference. In some embodiments, the frame of reference can be based on a default orientation of one or more sensors, such as IMU sensors 752, a default orientation of mobile device 104, and/or the Earth (e.g., an Earth-centered, Earth-fixed frame of reference, a north-east-down frame of reference, and/or an earth-centered inertial frame of reference). Additionally, or alternatively, orientation engine 772 may be configured to determine a relative orientation of mobile device 104 with respect to another device.

Based on a detected orientation of mobile device 104 by orientation engine 772, orientation engine 772 may cause one or more operations of mobile device 104 to be adjusted. For example, after determining that mobile device 104 is oriented such that a vertical axis of mobile device 104 is aligned with gravity, or within a predefined threshold alignment with gravity, orientation engine 772 may cause UWB interface 764 to increase a scanning frequency to detect nearby UWB enabled devices and/or update a list of the current UWB enable devices within a predefined threshold distance of mobile device 104.

Gesture engine 776 may be configured to recognize gestures performed by a user holding and/or operating mobile device 104. Gesture engine 776 may recognize gestures based on one or more changes in orientation provided by orientation engine 772, such as a change in orientation from a first orientation to a second orientation. Gesture engine 776 may detect whether a user has performed a gesture by determining whether or not the user has continuously moved mobile device 104 from a predefined starting orientation to a predefined ending orientation. For example, gesture engine 776 may determine that the user has moved mobile device from a starting orientation in which a vertical axis of mobile device 104 is perpendicular to a ground plan to an ending orientation in which the vertical axis is parallel with the ground plane (i.e., the user has performed a rotational gesture). Rotational gestures may be detected using one or more gyroscopic and/or magnetic measurements collected by IMU sensors 752. Additionally, or alternatively, gesture engine 776 may recognize gestures based on one or more movements detected while maintaining mobile device 104 in substantially the same orientation. For example, gesture engine 776 may determine that the user has moved mobile device forward, backward, and/or side-to-side, while maintaining an orientation in which the vertical axis is perpendicular to the ground plane (i.e., the user has performed a translational gesture). Forward, backward, and/or side-to-side movements (e.g., translational movements) of mobile device may be determined using one or more acceleration measurements collected by IMU sensors 752.

In some embodiments, gestures are recognized as two or more motions in a sequence (e.g., rotations and/or translations) of the mobile device. For example, a sequence of translational movements includes a first motion from side-to-side, a second motion up or down, a third motion side-to-side, and a fourth motion down or up may be recognized as a “square” shaped gesture. Additional gestures may be defined for similar types of shapes, such as circles, triangles, and the like, and may further be distinguished by the initial direction in which the shape is formed (e.g., a clockwise circle versus a counterclockwise circle). Additionally, or alternatively, different gestures may be defined for a same shape made within a different plane. For example, a square shape with side-to-side and up-and-down motion may correspond to a first gesture, a second square shape with up-and-down and forward and backward motion may correspond to a second gesture, and a third square shape with side-to-side and forward and backward motion may correspond to a third gesture.

In some embodiments, gestures are further recognized using acceleration measurements associated with motions of the mobile device. For example, a quick side-to-side (translational) motion may correspond to a first gesture and a slower side-to-side motion may correspond to a second gesture. Additionally, or alternatively, gestures may be recognized based on a timing associated with gestures. For example, a sequence of motions may only be recognized as a gesture if the entire sequence occurs within a predefined maximum amount of time. While many exemplary gestures are described herein, additional or alternative gestures may be defined to provide additional disambiguation from accidental or routine motion experienced by a mobile device. As such, gesture engine 776 may be configured to distinguish between motion of the mobile device that occurs during routine operation of a mobile device from gestures associated with predefined functions of either mobile device 104 or one or more remote devices.

In response to detecting that a user has performed a gesture, gesture engine 776 can recognize the detected gesture by converting the data from orientation engine 772 during movement of mobile device 104 into motion vectors and comparing the motion vectors for the detected gesture to motion vectors for gestures in a list of defined gestures. Additionally, or alternatively, gesture engine 776 may use a neural network, or other artificial intelligence/machine learning model to classify movements of mobile device 104 as a gesture. In some embodiments, gesture engine 776 defines the gestures in the list of defined gestures by measuring the data output by orientation engine 772 while the user is performing the gestures in a gesture recognition set-up mode. The data output by orientation engine 772 may then be used to train one or more gesture classification models.

One or more gestures defined by, or for, gesture engine 776 may be associated with one or more functions of mobile device 104. For example, a gesture may be associated with initiating a remote device control mode. As another example, one or more gestures may be associated with respective controllable operations of a remote device, such as playing and pausing media playback, skipping to a next media track, adjusting a volume, and the like. In yet another example, one or more gestures may be associated with data transmission operations, such as transferring data or media playback between mobile device 104 and a remote device. In some embodiments, gestures associated with one or more functions of mobile device 104 and/or controllable operations of a remote device are predetermined. In some embodiments, detection of gestures associated with respective controllable operations are enabled in response to detection of a first gesture associated with initiating control of a remote device.

Additionally, or alternatively, gestures may be associated with particular remote devices and/or types of remote devices. For example, a first gesture (e.g., a square) may be defined to initiate control over smart speaker 604 and a second gesture (e.g., a circle) may be defined to initiate control over display 106. Such device specific and/or operation specific gestures may enable mobile device 104 to identify a particular remote device from a plurality of remote devices within close proximity to each other, as described further below.

Gesture engine 776 may be configured to monitor for gestures in response to one or more stimuli or conditions. For example, gesture engine 776 may begin monitoring for movement of mobile device 104 according to a prescribed gesture in response to a determination that mobile device 104 is in a prescribed orientation (e.g., as determined by orientation engine 772). As another example, gesture engine 776 may begin monitoring for movement of mobile device 104 according to a prescribed gesture in response to a determination that mobile device 104 is in a handheld position and/or pointing at a remotely controllable device, as described further below. Monitoring for prescribed gestures in response to one or more conditions may improve operations of mobile device 104 by limiting resource consumption (e.g., processing power and energy) by gesture engine 776 to periods of time in which gestures are likely to have been intentionally made by a user and/or are likely to successfully achieve a desired result, such as controlling a remotely controllable device.

In response to detecting a prescribed gesture, gesture engine 776 may transmit an indication that mobile device 104 was moved according to the prescribed gesture to one or more subsequent modules executable by processing system 768, such as remote device mapper 784, remote device interface 788, and/or voice command engine 792. For example, after detecting a prescribed gesture associated with initiating control of a remotely controllable device by mobile device 104, gesture engine 776 may transmit an indication of such gesture to remote device mapper 784 to identify a candidate device for remote control, as described further below. As another example, gesture engine 776 may transmit an indication of a gesture associated with one or more media playback controls to remote device interface 788 to initiate transmission of a command signal to control a corresponding operation of a remote device. In yet another example, voice command engine 792 may begin monitoring for one or more voice command inputs in response to receiving an indication of a gesture associated with automatic speech recognition (ASR) activation.

Handheld detector 780 may be configured to determine that mobile device 104 is in a handheld position. Handheld detector 780 may determine that mobile device 104 is in a handheld position based on an orientation of mobile device 104 (e.g., as determined by orientation engine 772). Additionally, or alternatively, handheld detector 780 may determine that mobile device 104 is in a handheld position based on one or more inputs from IMU sensors 752. For example, handheld detector 780 may apply one or more classification engines to accelerometer, magnetometer, and/or gyroscope measurements to identify movement of mobile device 104 associated with handheld use.

As described above, determining that mobile device 104 is in a handheld position may be a condition or trigger for one or more subsequent functionalities or operations of mobile device 104. For example, after determining that mobile device 104 is in a handheld position, handheld detector 780 may transmit an indication to gesture engine 776 to begin monitoring for one or more prescribed gestures. As another example, UWB interface 764 may increase a scan rate frequency for detecting nearby devices and/or the distance and direction from mobile device 104 to a remote device based on a determination that mobile device 104 is in a handheld position. Controlling one or more operations of mobile device 104 in response to determining that mobile device 104 is in a handheld position may improve operations of mobile device 104 by limiting resource consumption (e.g., processing power and energy).

Remote device mapper 784 may be configured to determine a distance and direction between mobile device 104 and one or more devices of smart home environment 700. Remote device mapper 784 may determine the distance and direction from mobile device 104 to another device based on data received and/or generated by UWB interface 764. For example, remote device mapper 784 may receive one or more measurements from UWB interface 764 associated with one or more UWB messages received by UWB interface 764 from a remote device, such as the angle of arrival (AOA), time difference of arrival (TDoA), two-way ranging (TWR), time-of-flight (ToF), and phase-difference of arrival (PDoA). Based on one or more of these measurements, remote device mapper 784 may determine the distance and direction from mobile device 104 to another UWB enabled device. The direction from mobile device 104 to another device may be relative to a same, or similar, frame of reference used to define the orientation of mobile device 104. For example, the direction from mobile device 104 to another device may be measured as an angular offset from an antenna boresight, an axis perpendicular to a surface of mobile device 104 (e.g., a back or front of mobile device 104), and the like.

In some embodiments, remote device mapper 784 uses the distance and direction from mobile device 104 to one or more devices to determine a distance and direction from mobile device 104 to a particular device. For example, based on a distance and direction from mobile device 104 to a first device, and a distance and direction from the first device to a second device, remote device mapper 784 may determine the distance and direction from mobile device 104 to the second device. As another example, based on the distance from mobile device 104 to a first device, the distance and direction from mobile device 104 to a second device, and the distance from the first device to the second device, a direction from mobile device 104 to the first device may be determined. Remote device mapper 784 may utilize the distances and/or directions between mobile device 104 and multiple devices to determine the distance and/or direction to another device when the distance and/or direction is not directly ascertainable from the other device. This may be the case when, for example, the other device does not include UWB capabilities. Instead, other ranging techniques (e.g., using Bluetooth®) may be used to determine a range, and the distance and/or direction to other UWB enabled devices may be used to supplement the direction determination.

Based on the distance and direction from mobile device 104 to a remotely controllable device, remote device mapper 784 may determine that mobile device 104 is pointing at the remotely controllable device. For example, when the direction, or heading, from mobile device 104 to another device is within a predefined threshold of zero degrees, remote device mapper 784 may determine that mobile device 104 is pointing at the remote device. As described above, the direction, or heading, from mobile device 104 to another device may be defined in relation to a reference point or plane on mobile device 104, such as a front or back surface of mobile device 104.

In some embodiments, remote device mapper 784 determines that mobile device 104 is pointing at a plurality of remote devices. For example, remote device mapper 784 may determine that the respective headings from mobile device to two or more remote devices are within a predefined threshold of a reference heading for mobile device 104. In response, remote device mapper 784 may determine that mobile device 104 is pointing at the two or more remote devices. As described further herein, a particular remote device of the two or more remote devices may be identified for remote control upon detecting a prescribed gesture associated with the particular remote device, or a function exclusive to the particular remote device.

Remote device mapper 784 may use inputs from IMU sensors 752 to further supplement or estimate the distance and direction from mobile device 104 to a remotely controllable device. For example, after determining a distance and direction from mobile device 104 to a remotely controllable device using inputs from UWB interface 764, IMU sensors 752 may be used to monitor the movement of mobile device 104 within a space after the initial distance and direction are determined and adjust the distance and direction measurements based on the associated movements detected by IMU sensors 752. Supplementing such determinations with measurements from IMU sensors 752 may reduce energy and processing consumption by more power and/or processor heavy computations associated with using UWB interface 764 to continually calculate and/or recalculate the distance and direction from mobile device 104 to another device.

In some embodiments, remote device mapper 774 maintains a list of nearby remotely controllable devices detected during periodic scans of the environment within which mobile device 104 is located. For example, remote device mapper 774 may cause UWB interface 764 to scan for nearby devices every 7 second, 5 second, 30 seconds, 7 minute, or other suitable amount of time selected to balance the dual constraints associated with maintaining an accurate list of nearby devices and reducing power and/or processing consumption.

Remote device interface 788 may configure mobile device 104 to connect with and control remotely controllable devices. For example, after determining that mobile device 104 has been moved according to a prescribed gesture (e.g., by gesture engine 776) while mobile device 104 was pointed at a remotely controllable device (e.g., by remote device mapper 784), remote device interface 788 may initiate a connection between mobile device 104 and the remotely controllable device. Remote device interface 788 may further identify, or confirm the identity, of the remote device to which mobile device 104 was pointed based on the detected gesture. Using a combination of the direction and gesture may enable remote device interface 788 to distinguish between multiple remote devices toward which mobile device 104 was pointing. For example, in an environment with multiple remote devices in close proximity (e.g., a television display stand including display 106, smart speaker 604, and a hub device or display assistant device 190 in close proximity), remote device interface 788 may identify a first remote devices based on a determination that a particular gesture associated with the first remote device was detected while mobile device 104 was pointing in the general direction of each device.

Remote device interface 788 may initiate the connection directly with the remotely controllable device (e.g., using UWB or Bluetooth®) or indirectly through one or more networks, such as a Wi-Fi or mesh network via an access point, such as an edge router (e.g., display assistant device 190). After establishing a connection between mobile device 104 and a remotely controllable device, remote device interface 788 may begin transmitting commands to control one or more operations of the remotely controllable device. Remote device interface 788 may transmit commands in response to receiving and/or detecting one or more inputs and/or interactions at mobile device 104. For example, in response to receiving an indication that mobile device 104 has been moved according to a gesture associated with a particular control function, remote device interface may transmit a command corresponding to the control function to the remotely controllable device.

As another example, remote device interface 788 may configure mobile device 104 to present a GUI (e.g., via display 744) including a first collection of selectable actions corresponding to one or more operations of the remotely controllable device. In some embodiments, the collection of selectable actions is specific to the remotely controllable device. For example, the selectable actions associated with controls for smart thermostat 122 may include one or more thermostat control actions, while the selectable actions associated with controls for smart speaker 604 and/or smart camera 132 may include one or more media playback controls.

In some embodiments, remote device interface 788 determines whether mobile device 104 is approved to control a remotely controllable device. For example, after determining that mobile device 104 has been moved according to a prescribed gesture (e.g., by gesture engine 776) while mobile device 104 was pointed at a remotely controllable device (e.g., by remote device mapper 784), remote device interface 788 may determine whether mobile device 104 and the remotely controllable device are within a same control network and/or whether mobile device 104 is included in a list of devices approved for control over the remotely controllable device.

Determining whether mobile device 104 is approved to control a remotely controllable device may include determining whether the remotely controllable device is accessible via a same network to which mobile device 104 is currently connected, such as a local or home Wi-Fi network. Additionally, or alternatively, remote device interface 788 may query a management device, such as display assistant device 190 or a hub device, with which the remotely controllable device is in communication, for one or more credentials. Such credentials may be associated with the remotely controllable device, which when transmitted to the remotely controllable device from mobile device 104 along with a command signal, enable the remotely controllable device to operate in accordance with the command signal. Additionally, or alternatively, the credentials may enable mobile device 104 to join a particular network in which the remotely controllable device is a part. Additional details regarding authorization to control remotely controllable devices are described in further reference to FIG. 6 above.

Voice command engine 792 may be configured to convert audio recorded by mobile device 104 into various command inputs actionable by mobile device 104. Voice command engine 792 may utilize various spoken language understanding (SLU) functionality including speech recognition and natural language understanding (NLU) functionality to convert recorded audio into command inputs. Additionally, or alternatively, voice command engine 792 may transmit the recorded audio to an external process, such as a cloud-based speech recognition server system, for processing. After transmitting the audio recording to the external process, voice command engine 792 may receive one or more commands corresponding to spoken commands included in the audio recording for subsequent action by voice command engine 792. Based on the commands identified during speech recognition, voice command engine 792 may cause remote device interface 788 to transmit the one or more commands to a remotely controllable device to control one or more corresponding operations of the remotely controllable device.

Voice command engine 792 may begin recording audio for voice command recognition in response to a physical interaction with mobile device 104 (e.g., via physical user interfaces 748) and/or in response to detecting one or more spoken “hotwords”. Additionally, or alternatively, voice command engine 792 may begin processing audio recordings for speech recognition in response to gesture engine 776 determining that mobile device 104 was moved according to a prescribed gesture associated with initiation of automatic speech recognition.

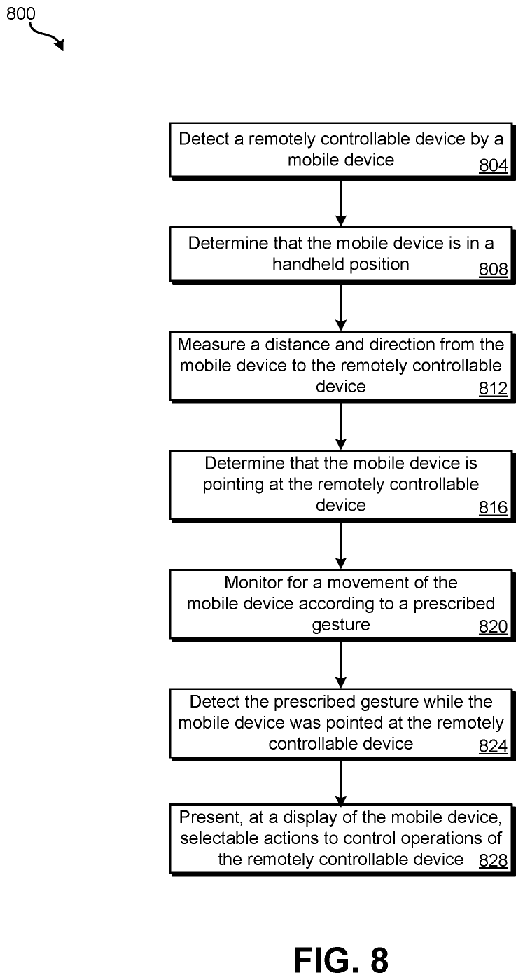

Various methods may be performed using the systems and arrangements of FIGS. 1-7. FIG. 8 illustrates an embodiment of a method 800 for controlling a remotely controllable device by a mobile device. Method 800 may be performed using mobile device 104, or some other form of mobile computing device configured to function in a same, or similar, manner as mobile device 104 described above. Additionally, or alternatively, one or more blocks of method 800 may be performed, or facilitated, by a remotely controllable device. The remotely controllable device may be a smart device, such as a smart thermostat, smart speaker, television, and the like, as described above. Together, the mobile device and remotely controllable device may be a part of, or connected within, a smart home environment. For example, the mobile device may be configured to communicate indirectly with the remotely controllable device via one or more network connections, or directly via one or more device-to-device communication protocols.

Method 800 may include, at block 804, detecting a remotely controllable device by a mobile device. The mobile device may detect the remotely controllable device using one or more communication protocols, such as Wi-Fi, Bluetooth®, UWB, and the like. The mobile device may detect the remotely controllable device as part of a regular, or semi-regular, scan of the surrounding environment. Scanning the surrounding environment may include transmitting a broadcast discovery and/or identification request using the communication protocol. For example, the mobile device may broadcast an identification associated with the mobile device as well as a request for devices receiving the broadcast to transmit, in response, their associated identifying information.

In some embodiments, the mobile device detects a plurality of remotely controllable devices in the environment. After detecting the one or more remotely controllable devices, the mobile device may maintain a list of detected devices. The remotely controllable devices may be stored in the list with one or more pieces of information associated with the respective remotely controllable device, such as a type of the device, one or more operations performable by the device, one or more access controls restricting control of the device, and the like.

At block 808, it is determined that the mobile device is in a handheld position. The mobile device may determine that it is in a handheld based at least in part on one or more movements of the mobile device. For example, using one or more IMU sensors, such as an accelerometer, gyroscope, and/or magnetometer, as described above in reference to IMU sensors 752, one or more movements of the mobile device may be detected. The one or more movements may then be analyzed to determine whether they correspond with handheld use of the mobile device by a user of the mobile device. Analyzing the one or more movements may include comparing the magnitude of the one or more movements with a predefined threshold movement magnitude associated with handheld use. Additionally, or alternatively, one or more AI/ML classification engines may be applied to the accelerometer, magnetometer, and/or gyroscope measurements to identify movement of mobile device associated with handheld use.

In some embodiments, determining that the mobile device is in a handheld position is a condition or trigger for one or more subsequent functionalities or operations of the mobile device. For example, after determining that the mobile device is in a handheld position, a scan rate frequency for a communication protocol associated with detecting nearby devices, such as UWB and/or Bluetooth®.

At block 812, a distance and direction from the mobile device to the remotely controllable device is measured. The mobile device may measure the distance and direction from the mobile device to the remotely controllable device using a wireless communication protocol, such as UWB and/or Bluetooth®. For example, based on one or more UWB messages received by a UWB interface, such as UWB interface 764 described above, from the remotely controllable device, measurements, such as AOA, TDoA, ToF, and PDoA, associated with the UWB messages may be used to determine the distance and direction from the mobile device to the remotely controllable device.

In some embodiments, the use of UWB, and/or an increased frequency at which UWB messages are transmitted/received by the mobile device, to measure the distance and direction from the mobile device to a remotely controllable device is activated in response to mobile device detecting one or more conditions or triggers. For example, a UWB scan rate may be increased in response to detecting the remotely controllable device using a separate communication protocol, such as Wi-Fi and/or Bluetooth®. As another example, the UWB scan rate may be increased in response to determining that the mobile device is at, or within a threshold deviation from, a predefined orientation, as described above.

The mobile device may measure the distance and direction from the mobile device to one or more additional remotely controllable devices detected by the mobile device. In some embodiments, the mobile device uses the distance and direction from the mobile device to the one or more additional remotely controllable devices to determine the distance and direction from the mobile device to the remotely controllable device. For example, as further described above, the mobile device may triangulate the distance and direction from the mobile device to the remotely controllable device using one, or a combination, of distance and direction measurements from the mobile device to other remotely controllable devices as well as any one, or a combination of distance and direction measurements between the remotely controllable devices.

At block 816, it is determined that the mobile device is pointing at the remotely controllable device. Determining that the mobile device is pointing at the remotely controllable device may be based, at least in part, on the distance and direction from the mobile device to the remotely controllable device. For example, when the direction, or heading, from the mobile device to the remotely controllable device is within a predefined threshold of zero degrees from a reference axis, such as an axis orthogonal to a surface of the mobile device, it may be determined that the mobile device is pointing at the remotely controllable device. In some embodiments, determining that the mobile device is pointing at the remotely controllable device is further based on a second distance and a second direction from the mobile device to a second remotely controllable device, and a third distance from the remotely controllable device to the second remotely controllable device, as further described above.

At block 820, movement of the mobile device according to a prescribed gesture is monitored. The mobile device may begin monitoring for the prescribed gesture in response to one or more stimuli or conditions. For example, the mobile device may begin monitoring for the prescribed gesture in response to a determination that the mobile device is in a prescribed orientation. As another example, the mobile device may begin monitoring for the prescribed gesture in response to a determination that the mobile device is in a handheld position and/or pointing at the remotely controllable device, as described further below. In some embodiments, the mobile device will stop monitoring for the prescribed gesture in response to the one or more conditions no longer being met. For example, after beginning to monitor for the prescribed gesture in response to determining that the mobile device is pointing at the remotely controllable device, the mobile device may stop monitoring for the prescribed gesture in response to a determination that the mobile device is no longer pointing at the remotely controllable device.

As described above, a gesture may include one or more movements (e.g., translational and/or rotational movements) of the mobile device in a predefined manner, order, and/or direction. For example, a gesture may include translational movement towards, then away from, the remotely controllable device. Monitoring for the prescribed gesture may include monitoring changes in orientation of the mobile device. As described above, the relative orientation, and any changes thereof, of the mobile device may be determined using one or more motion sensors, including accelerometers, gyroscopes, magnetometers, and the like. Additionally, or alternatively, the relative orientation for the mobile device with respect to other electronic devices may be translated to an orientation of the mobile device with respect to real world coordinates.

At block 824, the prescribed gesture is detected while the mobile device was pointed at the remotely controllable device. As described above, the mobile device may detect that it was moved according to the prescribed gesture based at least in part on one or more changes in orientation or movement of the mobile device. In some embodiments, the mobile device recognizes the prescribed gesture by converting the orientation and/or motion data into motion vectors and comparing the motion vectors for a detected gesture to motion vectors for gestures in a list of defined gestures. Additionally, or alternatively, the mobile device may use a neural network, or other AI/ML model to classify the movements of the mobile device as the prescribed gesture.

After detecting that the mobile device was moved according to the prescribed gesture, the mobile device may determine whether the prescribed gesture was made while the mobile device was pointing at the remotely controllable device. For example, the mobile device may determine whether the mobile device was pointing at the remotely controllable device, as described in relation to block 816, immediately before, during, and/or after completion of the prescribed gesture. In some embodiments, the mobile device identifies the remotely controllable device from a plurality of remotely controllable devices detected in the surrounding environment for control based on the determination that the mobile device was pointed at the remotely controllable device when the prescribed gesture was detected. Additionally, or alternatively, the mobile device may identify the remotely controllable device from the plurality of remotely controllable devices based on a determination that the prescribed gesture is associated with the remotely controllable device. For example, if the mobile device is pointing in the direction of a first device or a second device within close proximity to each other, detection of a specific gesture associated with the first device may be used to determine that the first device was the intended target of the prescribed gesture.

At block 828, a first collection of selectable actions to control one or more operations of the remotely controllable device are presented at a display of the mobile device. The mobile device may present the first collection of selectable actions in response to detecting that the mobile device was moved according to the prescribed gesture while the mobile device was pointed at the remotely controllable device. The first collection of selectable actions may include GUI elements, such as one or more buttons, sliders, and the like. The GUI elements may be specific to a type of the remotely controllable device and/or a subset of operations performable by the remotely controllable device. For example, as described above, the first collection of selectable actions for a smart speaker or television may include one or more media playback actions (e.g., play, pause, skip, rewind, etc). Additionally, or alternatively, the GUI elements may include one or more options to select the remote device from a plurality of remote devices in close proximity to the remote device.

In some embodiments, the first collection of selectable actions is presented in a first widget associated with one or more functions of the remotely controllable device. For example, some remotely controllable devices, such as a smart speaker and microphone combination device, or a hub device, may include a first set of functions associated with media playback and a second set of functions associated with two-way communications. Depending on one or more factors, the first collection of selectable actions associated with a first set of functions may be displayed by the mobile device in addition to an option to view a second collection of selectable actions associated with the second set of functions.

Method 800 may continue by receiving a selection of a first action corresponding to a first operation of the remotely controllable device. In response to receiving the selection of the first action, the mobile device may transmit a command to control the first operation of the remotely controllable device. The mobile device may transmit the command using a same, or similar wireless communication as used to detect the remotely controllable device. For example, the mobile device may transmit the command via a Wi-Fi and/or mesh network connection with the remotely controllable device.

Additionally, or alternatively, method 800 may continue by detecting that the mobile device was moved according to a second prescribed gesture. The second prescribed gesture may be associated with one of the one or more selectable actions and/or may correspond to one of the one or more operations of the remotely controllable device. Stated differently, after presenting the one or more selectable options at the display of the mobile device, the remotely controllable device may be controlled in accordance with a user selection (e.g., via interaction with a touchscreen display) of a selectable action, or by determining that a user has performed a unique gesture associated with the selectable action. Subsequent gestures associated with the one or more selectable actions may be detected while the mobile device remains pointed at the remotely controllable device, or alternatively, until the mobile device receives an indication that a user no longer wishes to control the remotely controllable device via the mobile device.

In some embodiments, method 800 continues by detecting that the mobile device was moved according to the prescribed gesture while the mobile device is no longer pointed at the remotely controllable device. This may occur when a user wishes to stop controlling the initial remotely controllable device and/or begin controlling a second remotely controllable device. For example, by performing the prescribed gesture while the mobile device is pointing at the second remotely controllable device, control by the mobile device of the initial remotely controllable device may be transferred to the second remotely controllable device. After detecting the prescribed gesture while the mobile device was pointed at a second remotely controllable device, the mobile device may present a second collection of selectable actions to control one or more operations of the second remotely controllable device.

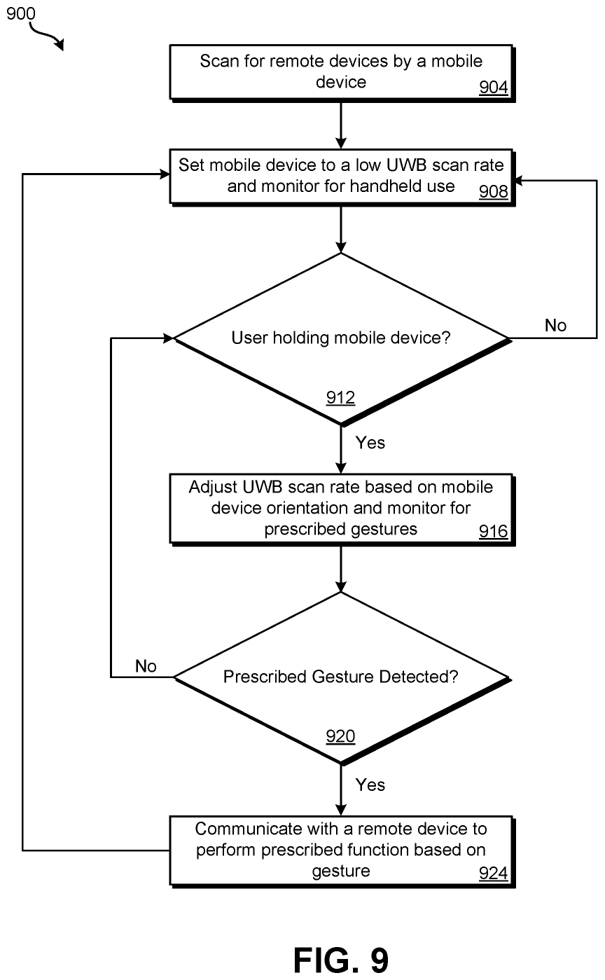

FIG. 9 illustrates another embodiment of a method 900 for controlling a remotely controllable device by a mobile device. Method 900 may be performed using mobile device 104, or some other form of mobile computing device configured to function in a same, or similar, manner as mobile device 104 described above. Additionally, or alternatively, one or more blocks of method 900 may be performed, or facilitated, by a remotely controllable device. The remotely controllable device may be a smart device, such as a smart thermostat, smart speaker, television, and the like, as described above. Together, the mobile device and remotely controllable device may be a part of, or connected within, a smart home environment. For example, the mobile device may be configured to communicate indirectly with the remotely controllable device via one or more network connections, or directly via one or more device-to-device communication protocols.

Method 900 may include, at block 904, scanning for remote devices by a mobile device. The mobile device may scan for remotely controllable device using one or more communication protocols, such as Wi-Fi, Bluetooth®, UWB, and the like. The mobile device may scan for remotely controllable device as part of a regular, or semi-regular, scan of the surrounding environment. Scanning the surrounding environment may include transmitting a broadcast discovery and/or identification request using the communication protocol. For example, the mobile device may broadcast an identification associated with the mobile device as well as a request for devices receiving the broadcast to transmit their associated identifying information in response.

In some embodiments, in response to scanning for valid remote devices the mobile device detects one or more remotely controllable devices in the environment. After detecting the one or more remotely controllable devices, the mobile device may maintain a list of detected devices. Additionally, or alternatively, the mobile device may receive a list of remotely controllable devices from another device within the environment, such as a hub device. The remotely controllable devices may be stored in the list with one or more pieces of information associated with the respective remotely controllable device, such as a type of the device, one or more operations performable by the device, one or more access controls restricting control of the device, and the like.

At block 908, a low UWB scan rate is set for the mobile device and handheld use is monitored. The low UWB scan rate may be set in order to reduce power consumption by a UWB component of the mobile device, such as UWB interface 744 described above. The low UWB scan rate may further be set to maintain rough spatial awareness of remote devices within a predefined proximity to the mobile device. In some embodiments, a low UWB scan rate corresponds with deactivating UWB scanning altogether. For example, UWB scanning may be deactivated until it is determined that the mobile device is in a prescribed orientation, such as during handheld use. Monitoring for handheld use may include monitoring one or more sensor measurements provided by IMU sensors of the mobile device, such as an accelerometer, gyroscope, and/or magnetometer. Additionally, or alternatively, monitoring for handheld use may include monitoring for one or more interactions with a user interface, such as a physical button or touch screen display.

At decision block 912, it is determined whether a user is holding the mobile device. The mobile device may determine that it is in a handheld based at least in part on one or more movements of the mobile device. For example, using one or more IMU sensors, such as an accelerometer, gyroscope, and/or magnetometer, as described above in reference to IMU sensors 752, one or more movements of the mobile device may be detected. The one or more movements may then be analyzed to determine whether they correspond with handheld use of the mobile device by a user of the mobile device. Analyzing the one or more movements may include comparing the magnitude of the one or more movements with a predefined threshold movement magnitude associated with handheld use. Additionally, or alternatively, one or more AI/ML classification engines may be applied to the accelerometer, magnetometer, and/or gyroscope measurements to identify movement of mobile device associated with handheld use. If, at decision block 912, it is determined that a user is not holding the mobile device, method 900 may return to block 908 to continue monitoring for handheld use.

At block 916, in response to determining that a user is holding the mobile device, the UWB scan rate is adjusted based on mobile device orientation and prescribed gestures are monitored. Adjusting the UWB scan rate may include increasing a frequency at which UWB messages are transmitted/received by the mobile device, to measure the distance and direction from the mobile device to one or more remotely controllable devices. The UWB scan rate may be increased in response to determining that the mobile device is at, or within a threshold deviation from, a predefined orientation, as described above. The mobile device may measure the distance and direction from the mobile device to one or more additional remotely controllable devices detected by the mobile device. In some embodiments, the mobile device uses the distance and direction from the mobile device to the one or more additional remotely controllable devices to determine the distance and direction from the mobile device to the remotely controllable device. For example, as further described above, the mobile device may triangulate the distance and direction from the mobile device to the remotely controllable device using one, or a combination, of distance and direction measurements from the mobile device to other remotely controllable devices as well as any one, or a combination of distance and direction measurements between the remotely controllable devices.

The mobile device may begin monitoring for the prescribed gesture in response to a determination that the mobile device is in a prescribed orientation. As another example, the mobile device may begin monitoring for the prescribed gesture in response to a determination that the mobile device is pointing at a remotely controllable device, as described further below. In some embodiments, the mobile device intermittently monitors for prescribed gestures. For example, after beginning to monitor for a prescribed gesture in response to determining that the mobile device is pointing at a remotely controllable device, the mobile device may stop monitoring for a prescribed gesture in response to a determination that the mobile device is no longer pointing at the remotely controllable device.

As described above, a gesture may include one or more movements (e.g., translational and/or rotational movements) of the mobile device in a predefined manner, order, and/or direction. For example, a gesture may include translational movement towards, then away from, the remotely controllable device. Monitoring for the prescribed gesture may include monitoring changes in orientation of the mobile device. As described above, the relative orientation, and any changes thereof, of the mobile device may be determined using one or more motion sensors, including accelerometers, gyroscopes, magnetometers, and the like. Additionally, or alternatively, the relative orientation for the mobile device with respect to other electronic devices may be translated to an orientation of the mobile device with respect to real world coordinates.

At decision block 920, it is determined whether a prescribed gesture is detected by the mobile device. As described above, the mobile device may detect that it was moved according to the prescribed gesture based at least in part on one or more changes in orientation or movement of the mobile device. In some embodiments, the mobile device recognizes the prescribed gesture by converting the orientation and/or motion data into motion vectors and comparing the motion vectors for a detected gesture to motion vectors for gestures in a list of defined gestures. Additionally, or alternatively, the mobile device may use a neural network, or other AI/ML model to classify the movements of the mobile device as the prescribed gesture. If, at decision block 920, a prescribed gesture is not detected, method 900 may return to decision block 912 to determine whether a user is still holding the mobile device.

On the other hand, if a prescribed gesture is detected, the mobile device may proceed to determine whether the prescribed gesture was made while the mobile device was pointing at a remotely controllable device. For example, the mobile device may determine whether the mobile device was pointing at a remotely controllable device immediately before, during, and/or after completion of the prescribed gesture. In some embodiments, the mobile device identifies a remotely controllable device from a plurality of remotely controllable devices detected in the surrounding environment for control based on the determination that the mobile device was pointed at the remotely controllable device when the prescribed gesture was detected. Additionally, or alternatively, the mobile device identifies a remotely controllable device from a plurality of remotely controllable devices detected in the direction toward which the mobile device was pointing in based on a determination that the detected gesture is associated with the remote device.

At block 924, in response to determining that a prescribed gesture was detected, a remote device is communicated with to perform a prescribed function based on the gesture. The mobile device may transmit a command using a same, or similar, wireless communication as used to scan for the remotely controllable device. For example, the mobile device may transmit the command via a Wi-Fi and/or mesh network connection with the remotely controllable device. In some embodiments, the command is selected from one or more commands associated with respective prescribed gestures that corresponds to a particular controllable function of the remotely controllable device. For example, after scanning for, and detecting, the remotely controllable device, the mobile device may identify one or more controllable functions of the remotely controllable device, such as playing/pausing a media playback. The mobile device may then identify a respective prescribed gesture that corresponds to each controllable function. The respective prescribed gestures may be identified from a default gesture setting for devices of a similar type and/or may be defined through one or more user interactions with the mobile device (e.g., through a device settings interface).

Additionally, or alternatively, a selection of the command may be received via one or more user interface interactions. For example, after detecting the prescribed gesture, the mobile device may display one or more GUIs. In some embodiments, after causing the remotely controllable device to perform the prescribed function, method 900 returns to block 908 to determine if the mobile device is still in handheld use and/or return the mobile device to a low UWB scan rate.

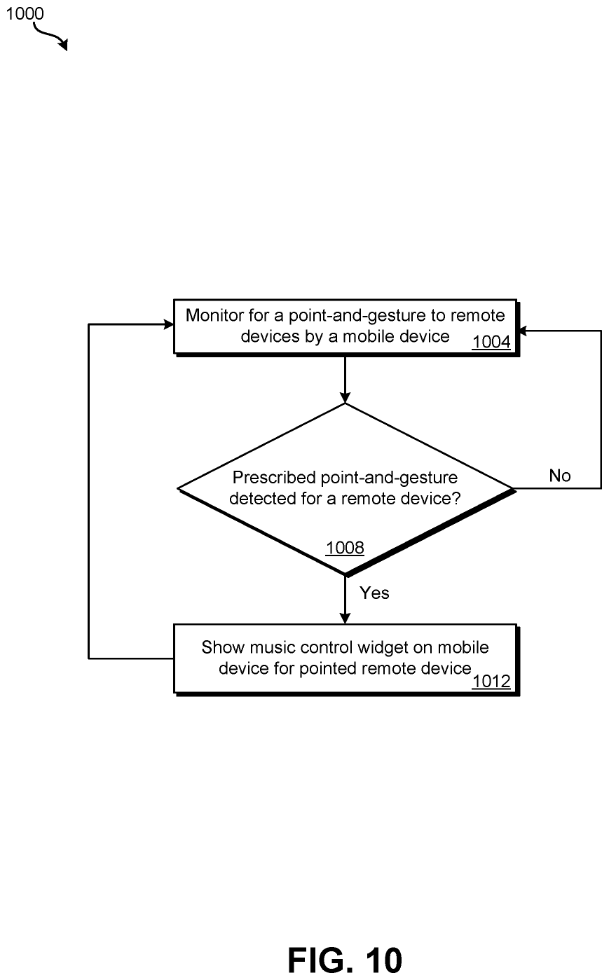

FIG. 10 illustrates an embodiment of a method 1000 for controlling music playback on a remotely controllable device by a mobile device. Method 1000 may be performed using mobile device 104, or some other form of mobile computing device configured to function in a same, or similar, manner as mobile device 104 described above. Additionally, or alternatively, one or more blocks of method 1000 may be performed, or facilitated, by a remotely controllable device. The remotely controllable device may be a smart device, such as a smart speaker, television, and the like, as described above. While not illustrated, method 1000 may begin with, or otherwise include some or all of the blocks described above in reference to methods 800 and/or 900. For example, prior to block 1004, method 1000 may include steps associated with scanning for remote devices, determining whether the device is in handheld use, and in response, adjusting a UWB scan rate.

Method 1000 may include, at block 1004, monitoring for a point-and-gesture to remote devices by a mobile device. Monitoring for a point-and-gesture may include measuring the distance and direction from the mobile device to one or more remotely controllable devices. Additionally, or alternatively, monitoring for a point-and-gesture may include monitoring changes in orientation of the mobile device as measured by one or more motion sensors and/or may be determined based on changes to the distance and/or direction from the mobile device to one or more remotely controllable devices.

At decision block 1008, it is determined whether a prescribed point-and-gesture was detected for a remote device. Determining that a prescribed point-and-gesture was detected for a remote device may include determining that the mobile device was moved according to a prescribed gesture while the mobile device was pointing toward the remote device. In some embodiments, determining that a prescribed point-and-gesture was detected for a remote device includes identifying the remote device from a plurality of devices. For example, before, during, or after detection of a gesture, it may be determined that the mobile device was pointing at two or more remote devices. A particular remote device from the plurality of remote devices may be identified for control based on a determination that the prescribed gesture is associated with the particular remote device, and/or a function exclusive to the remote device. If at decision block 1008, it is determined that a prescribed point-and-gesture was not detected, method 1000 may return to block 1004 to continue monitoring for a point-and-gesture.

At block 1012, in response to determining that a prescribed point-and-gesture was detected for a remote device, a music control widget is shown on the mobile device for the pointed remote device. The music control widget may be shown in further response to determining that the pointed remote device (i.e., the remote device toward which the mobile device was pointing while the prescribed gesture was made) is commonly associated with music or other audiovisual playback (e.g., a smart speaker, a television, and the like). Additionally, or alternatively, the music control widget may be shown in response to detecting a particular prescribed gesture associated with music playback. For instance, the pointed remote device may be further configured to perform additional functions, such as video playback, two-way communication, web browsing, and the like. As such, each function may be associated with a particular prescribed gesture whereupon detection of a prescribed gesture causes a widget to be shown for the associated function.

In some embodiments, after showing the music control widget on the mobile device, method 1000 returns to block 1004 to continue monitoring for a point-and-gesture to the same, or other, remote devices. For example, the mobile device may monitor for a subsequent point-and-gesture associated with a particular music control function whereupon detecting such gesture may cause the mobile device to transmit a corresponding command to the pointed remote device. Additionally, or alternatively, method 1000 may return to block 1004 after determining that a user of the mobile device has finished interacting with pointed remote device and/or the music control widget. For example, after receiving a selection at a user interface corresponding to a music control function, the mobile device may close the music control widget and continue monitoring for a subsequent point-and-gesture to control the same, or a different, remote device.

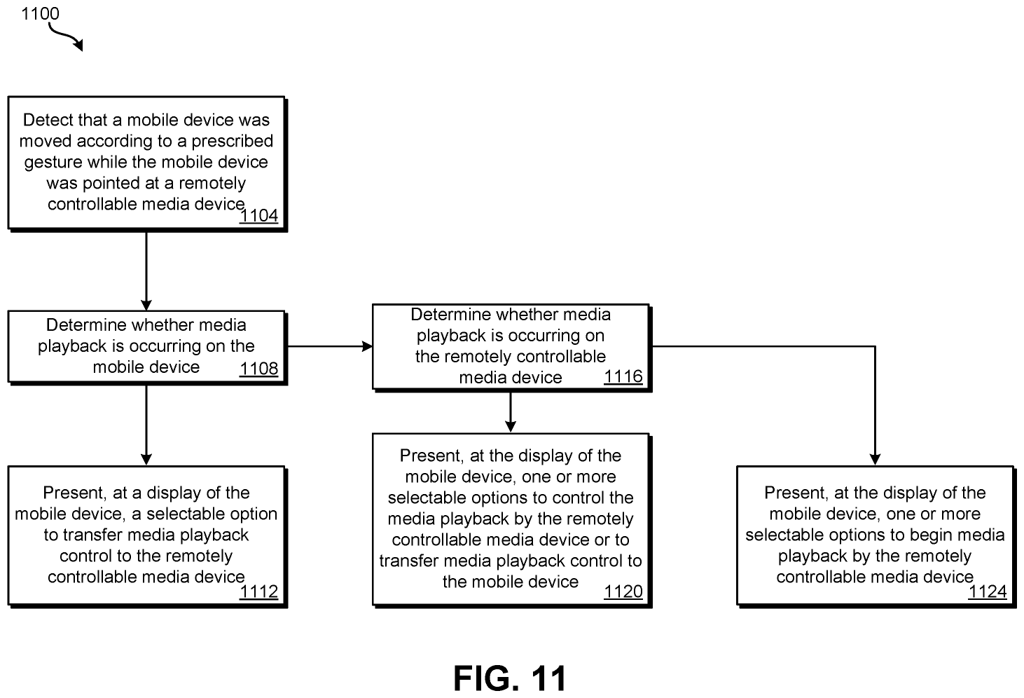

FIG. 11 illustrates an embodiment of a method 1100 for controlling and transferring media playback by a remotely controllable media device from a mobile device. Method 1100 may be performed using mobile device 104, or some other form of mobile computing device configured to function in a same, or similar, manner as mobile device 104 described above. Additionally, or alternatively, one or more blocks of method 1100 may be performed, or facilitated, by a remotely controllable media device configured for media playback, such as a smart speaker, television, and/or hub device including one or more speakers, a display, one or more cameras, and/or one or more microphones. Media playback may include playback of prerecorded audio and/or video content, such as from a music and/or video streaming platform. Additionally, or alternatively, media playback may include two-way communications, including voice and/or video calls between two or more participants. While not illustrated, method 1100 may begin with, or otherwise include some or all of the same blocks as method 800 described above. For example, prior to block 1104, method 1100 may include steps associated with detecting the remotely controllable media device, determining that the mobile device is in a handheld position, and determining that the mobile device is pointing at the remotely controllable media device.

At block 1104, movement of a mobile device according to a prescribed gesture is detected while the mobile device was pointed at the remotely controllable media device. As described above in relation to block 824, the mobile device may detect that it was moved according to the prescribed gesture based at least in part on one or more changes in orientation or movement of the mobile device. After detecting that the mobile device was moved according to the prescribed gesture, the mobile device may determine whether the prescribed gesture was made while the mobile device was pointing at the remotely controllable media device. In some embodiments, the mobile device identifies the remotely controllable media device for control by the mobile device from a plurality of remotely controllable media devices detected in the surrounding environment based on a determination that the mobile device was pointed at the remotely controllable device when the prescribed gesture was detected.

At block 1108, it is determined whether media playback is occurring on the mobile device. As described above, media playback may include playback of prerecorded audio and/or video content. For example, the mobile device may stream music and/or video from one or more internet streaming sources for output at a display and/or one or more audio outputs (e.g., speakers and/or headphone jacks) of the mobile device. Additionally, or alternatively, media playback may include one or more types of two-way communications. For example, media playback may include voice and/or video calls between the user of the mobile device and one or more additional participants using a combination of one or more audiovisual inputs (e.g., cameras and/or microphones) and outputs (e.g., speakers, electronic displays, and/or headphones).

If it is determined, at block 1108, that media playback is occurring on the mobile device, method 1100 may include, at block 1112, presenting a selectable option to transfer media playback control to the remotely controllable media device at a display of the mobile device. The selectable option may include a GUI element (e.g., a button) such as media playback transfer controls 326 described above. The selectable option may indicate that the current media playback may be transferred to the remotely controllable media device in response to a selection of the option. In some embodiments, mobile device is further configured to monitor for one or more subsequent gestures associated with the selectable action to transfer media playback control to the remotely controllable media device. The subsequent gesture may achieve the same result as a selection of the selectable option.

After receiving a selection of the selectable option, and/or detecting the subsequent gesture associated with the selectable option, the mobile device may stop the media playback, and the media playback may then continue from the remotely controllable device. For example, as described above in the context of media streaming, the mobile device may stop the playback of a currently playing music track, and the remotely controllable media device may continue playback of the currently playing music track from the same position when it was stopped by the mobile device. Additionally, or alternatively, playback of the music track may continue on the mobile device while a concurrent playback of the same music track may begin from the remotely controllable device. In some embodiments, after transferring control of the media playback to the remotely controllable media device, an indication of the ongoing media playback may remain on the display of the mobile device. For example, the mobile device may continue, or change displays, to indicate the currently playing media track and position of the media playback. Additionally, or alternatively, the mobile device may be updated to present one or more selectable options to continue control over the media playback by the remotely controllable media device (e.g., play/pause, skip, volume controls, and the like).

Similar results may be achieved for media playback associated with two-way communications. For example, after receiving a selection of the option to transfer control to the remotely controllable media device, audio from the other participants may emanate from the remotely controllable media device and audio from the user of the mobile device may be recorded by, and/or transmitted from, a microphone of the remotely controllable media device. Additionally, or alternatively, the mobile device may be updated to present one or more selectable options to continue control over ongoing communications, such as options to end the call, transfer the call back to the mobile device, add additional participants, mute the microphone and/or speaker, and the like.

In some embodiments, prior to presenting the selectable option to transfer media playback control, the mobile device first determines whether the capabilities of the remotely controllable media device will support the transfer of media playback control. For example, the mobile device may determine that the remotely controllable media device is a smart speaker with a microphone and speaker that may not support full transfer of an ongoing video call occurring on the mobile device. After determining that the remotely controllable media device may not support full transfer of the ongoing media playback, the mobile device may present one or more selectable options to transfer a subset of the ongoing media playback (e.g., only audio, or only video), or additional controls corresponding to one or more alternative functionalities of the remotely controllable media device.

If it is determined, at block 1108, that media playback is not occurring on the mobile device, method 1100 may include, at block 1116, determining whether media playback is occurring on the remotely controllable device. As described above in relation to block 1108, the media playback may include playback of prerecorded audio and/or video content or one or more types of two-way communications. Media playback by the remotely controllable media device may have been initiated in a same, or similar, manner as described above in relation to block 1112. For example, the media playback may have been transferred from the mobile device at some point in the past. Additionally, or alternatively, the media playback may have been initiated on the remotely controllable media device by the mobile device, as described further below, directly by the remotely controllable media device (e.g., via one or more user interfaces), or a second mobile device capable of controlling the remotely controllable media device.

If it is determined, at block 1116, that media playback is occurring on the remotely controllable media device, method 1100 may include, at block 1120, presenting one or more selectable options to control the media playback by the remotely controllable device or to transfer media playback control to the mobile device at a display of the mobile device. The one or more selectable options to control the media playback by the remotely controllable device may include some or all of the same options described above in relation to block 1112 presented after transferring control of the media playback to the remotely controllable media device. For example, the one or more selectable options may include options to control the media playback by the remotely controllable media device (e.g., play/pause, skip, volume controls, and the like).

The one or more selectable options to transfer media playback control to the mobile device may function in a similar manner as the selectable option to transfer media playback to the remotely controllable media device described above in relation to block 1112. For example, in the context of two-way communications, after receiving a selection of the option to transfer control to the mobile device, audio from other participants may stop emanating from the remotely controllable media device and instead begin emanating from one or more audio outputs of the mobile device.

If it is determined, at block 1116, that media playback is not occurring on the remotely controllable media device, method 1100 may include, at block 1124, presenting one or more selectable options to begin media playback by the remotely controllable device are presented at the display of the mobile device. In the context of prerecorded audio and/or video, the one or more selectable options may be presented as part of a widget configured to enable a user to browse through, and select from, a library of media available for playback by the remotely controllable media device such as music playlists, albums, individual tracks, podcasts, movies, prerecorded television shows, live television channels, previously recorded audio/visual from a smart camera, and the like. In the context of two-way communications, the selectable options may be presented as part of a widget configured to enable a user to browse through a list of existing contacts, enter details for new contacts, and initiate new communications (e.g., voice and/or video calls) with the new or existing contacts.

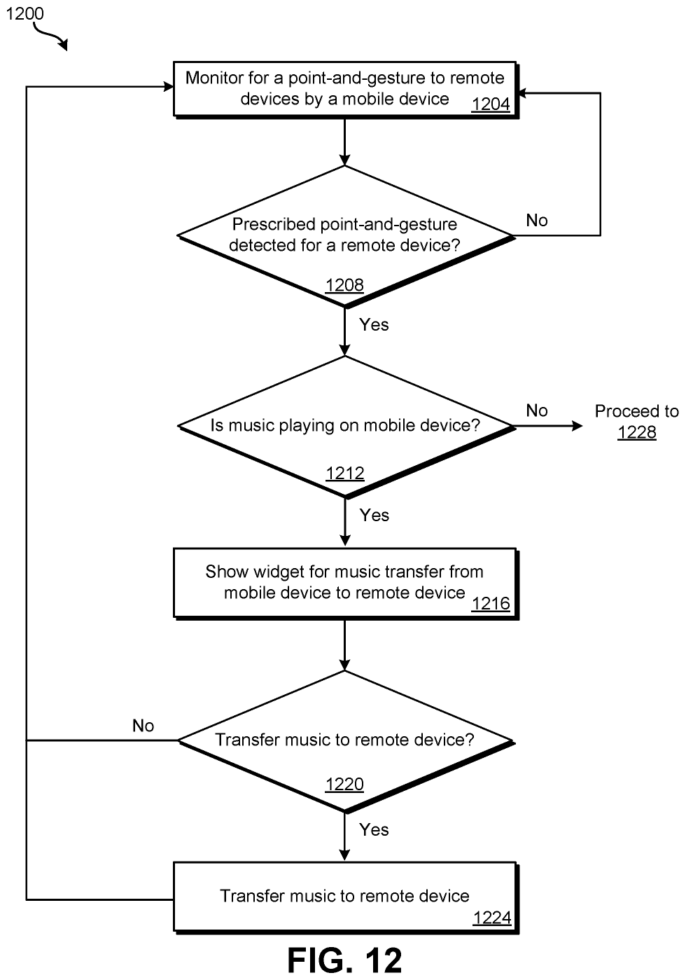

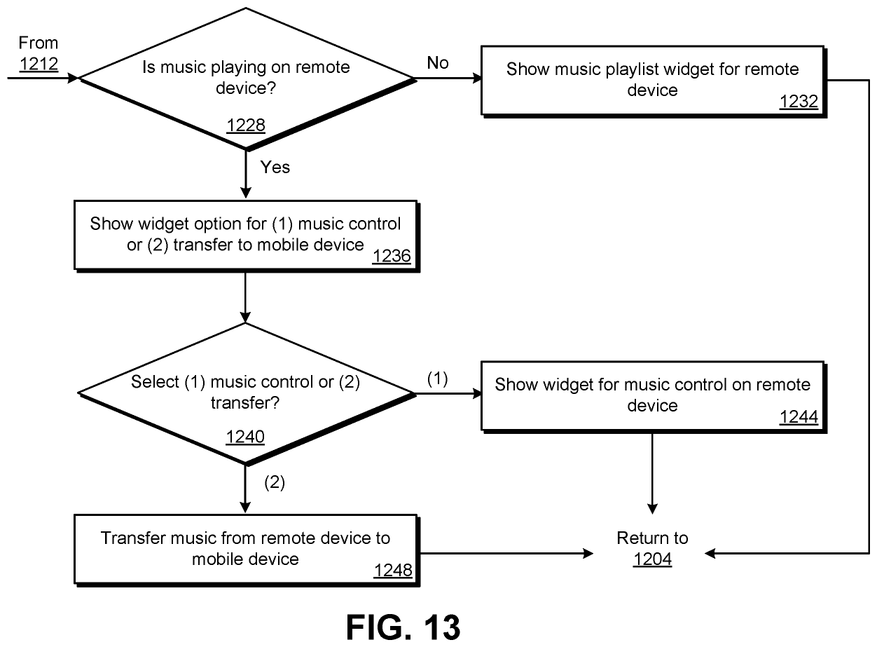

FIG. 12 & FIG. 13 illustrate an embodiment of a method 1200 for controlling and transferring music playback to and from a remotely controllable media device using a mobile device. Method 1200 may be performed using mobile device 104, or some other form of mobile computing device configured to function in a same, or similar, manner as mobile device 104 described above. Additionally, or alternatively, one or more blocks of method 1200 may be performed, or facilitated, by a remotely controllable media device configured for media playback, such as a smart speaker, television, and/or hub device including one or more speakers, a display, and/or one or more microphones. While not illustrated, method 1200 may begin with, or otherwise include some, or all, of the same blocks as method 800 described above. For example, prior to block 1204, method 1200 may include steps associated with detecting the remotely controllable media device, determining that the mobile device is in a handheld position, and determining that the mobile device is pointing at the remotely controllable media device.

Method 1200 may include, at block 1204, monitoring for a point-and-gesture to remote devices by a mobile device. Monitoring for a point-and-gesture may include measuring the distance and direction from the mobile device to one or more remotely controllable devices. Additionally, or alternatively, monitoring for a point-and-gesture may include monitoring changes in orientation of the mobile device as measured by one or more motion sensors and/or may be determined based on changes to the distance and/or direction from the mobile device to one or more remotely controllable devices.

At decision block 1208, it is determined whether a prescribed point-and-gesture was detected for a remote device. Determining that a prescribed point-and-gesture was detected for a remote device may include determining that the mobile device was moved according to a prescribed gesture while the mobile device was pointing toward the remote device. In some embodiments, determining that a prescribed point-and-gesture was detected for a remote device includes identifying the remote device from a plurality of devices. For example, before, during, or after detection of a gesture, it may be determined that the mobile device was pointing at two or more remote devices. A particular remote device from the plurality of remote devices may be identified for control based on a determination that the prescribed gesture is associated with the particular remote device, and/or a function exclusive to the remote device. If at decision block 1208, it is determined that a prescribed point-and-gesture was not detected, method 1200 may return to block 1204 to continue monitoring for a point-and-gesture.

At decision block 1212, in response to determining that a prescribed point-and-gesture was detected for a remote device, it is determined whether music is playing on the mobile device. While described as music, embodiments described herein may similarly apply to other types of auditory media, such as podcasts, audiobooks, and the like. Similarly, embodiments described herein may equally apply to audiovisual media, such as movies, shows, internet videos, and the like. For example, as described further herein, transferring music to a remote device may include transferring an audio component of audiovisual media, such as the audio track for a music video currently streaming on the mobile device. As another example, both the audio and video components of the music video may be transferred to devices coupled with a display.

Determining whether music is playing on the mobile device may include determining whether a music, or other audiovisual, application operating on the mobile device is currently outputting audio signals to an audio interface of the mobile device, such as a speaker, headphone, or Bluetooth® interface. Additionally, or alternatively, an operating system of the mobile device may include an indicator that music, or other audio playback is ongoing. A component of the mobile device configured to interface with remote devices, such as remote device interface 788 described above, may then query the operating system for the indicator to determine that music is currently being played. If at block 1212 it is determined that music is not playing on the mobile device, method 1200 may proceed to block 1228, as described further below.

At block 1216, in response to determining that music is playing on the mobile device, a widget for music transfer from the mobile device to the remote device is shown. The widget may include one or more GUI elements (e.g., buttons, drop down lists, and the like) indicating the availability of the remote device to begin playing the music, or other audio, by the remote device. The selectable option may indicate that the current music playback may be transferred to the remotely controllable device in response to a selection of the option. In some embodiments, the mobile device is further configured to monitor for one or more subsequent gestures associated with the selectable action to transfer media playback control to the remotely controllable device. The subsequent gesture may achieve the same result as a selection of the selectable option.

At decision block 1220, it is determined whether to transfer the music playback to the remote device. A determination that the music playback is to be transferred may be made in response to receiving a selection via the widget to transfer the music playback and/or by detecting a subsequent gesture associated with such a selection via the widget. If at block 1220 it is determined that the music playback is not to be transferred, method 1200 may return to block 1204 to begin monitoring for a subsequent point-and-gesture to the same, or another, remote device.

Alternatively, at block 1224, in response to determining that the music playback is to be transferred, the mobile device may transfer the music playback to the remote device. Transferring the music playback may include streaming the audio data associated with the music from the mobile device to the remote device via one or more wireless connections, such as via a local Wi-Fi connection, Bluetooth®, or other wireless communication. Alternatively, transferring the music playback may include transmitting information associated with the current music playback configured to enable the remote device to receive the audio data directly from the source, such as an internet media streaming server or other content host (e.g., content hosts 114). After completion of block 1224, method 1200 may return to block 1204 to begin monitoring for a subsequent point-and-gesture to the same, or another, remote device.

Referring now to FIG. 13, at decision block 1228, in response to determining that music is not playing on the mobile device, it is determined whether music is playing on the remote device. The mobile device may determine whether the remote device is currently playing music by transmitting a request to the remote device to identify one or more operations (such as music playback) currently being facilitated by the remote device. The request may be transmitted wirelessly from the mobile device to the remote device via one or more network connections, such as a Wi-Fi or mesh network connection. Music playback on the remote device may have been initiated in a same, or similar, manner as described above in relation to block 1224. As such, the mobile device may keep a record of such previous transfer, or ongoing streaming from the mobile device to the remote device, to determine whether the remote device is playing music. Additionally, or alternatively, the music playback may have been initiated by the remote device (e.g., via one or more user interfaces), or a second mobile device capable of controlling the remote device.

At block 1232, in response to determining that music is not playing on the remote device, a music playlist widget for the remote device is shown on the mobile device. The music playlist widget may include one or more GUIs enabling a user to browse through available media for playback by the remote device. For example, a first GUI may present one or more options for a user to select a particular content source, streaming service, and the like. Subsequent GUIs may include options to browse content categories, or collections of content saved by a user or other account holder of a particular content source. In some embodiments, upon selection of particular content, the mobile device transmits a request to the mobile device to begin playback of the selected content. After completion of block 1232, method 1200 may return to block 1204 to begin monitoring for a subsequent point-and-gesture.

At block 1236, in response to determining that music is playing on the remote device, a widget including a first option to control the music playback on the remote device and a second option to transfer the music playback to the mobile device is shown. Each option may be presented as a selectable option on a GUI. The widget may further include information pertaining to the music, or other media content, currently being played by the remote device, such as a track name, artist name, album name, playlist name, content source, movie title, video URL, and the like. While described as including two options, the widget may include additional options for controlling and/or transferring the music or other media playback. For example, additional options may be presented to transfer the music playback to another remote device and/or to begin playing the same content on another remote device in addition to the remote device currently playing the music.

At decision block 1240, it is determined whether the first option to control the music playback on the remote device or the second option to transfer the music playback to the mobile device was selected. A determination that the first, second, or other option has been selected may be made in response to receiving a selection via the widget to transfer the music playback and/or by detecting a subsequent gesture associated with such a selection via the widget.

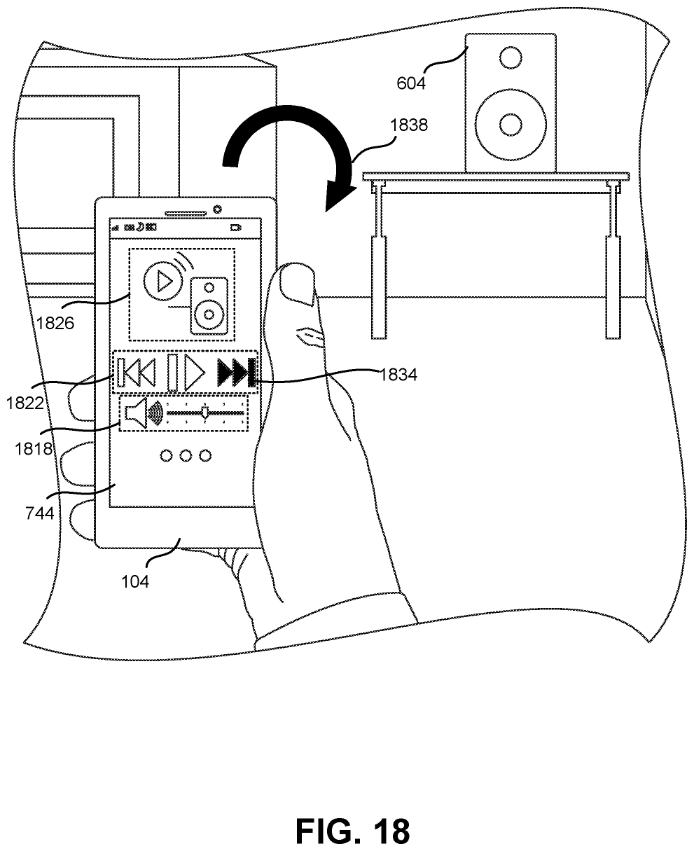

At block 1244, in response to determining that the first option to control the music playback on the remote device was selected, a widget to control the music playback on the remote device is shown on the mobile device, as described further below in reference to FIG. 18. Alternatively, at block 1248, in response to determining that the second option to transfer the music playback to the mobile device was selected, the music playback is transferred from the remote device to the mobile device. The music, or other media playback may be transferred to the mobile device in a similar fashion as described above at block 1224. For example, the remote device may begin streaming the music to the mobile device. Alternatively, the remote device may transmit information associated with the current music playback configured to enable the mobile device to receive the audio data directly from the source. After completion of block 1244, 1248, or both, method 1200 may return to block 1204 to begin monitoring for a subsequent point-and-gesture.

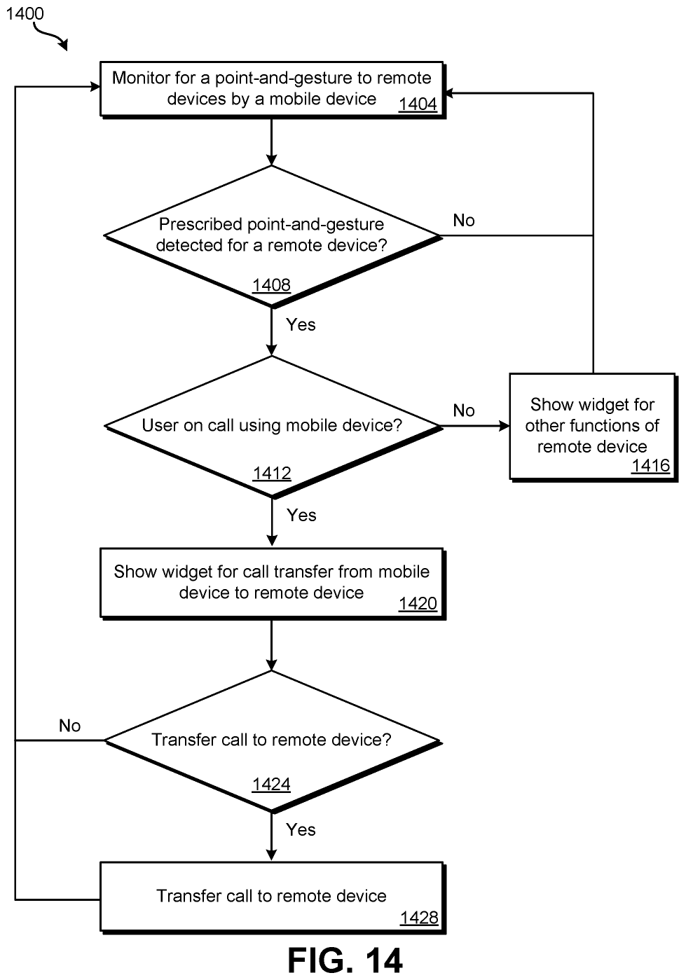

FIG. 14 illustrates an embodiment of a method 1400 for transferring communications to a remotely controllable device from a mobile device. Method 1400 may be performed using mobile device 104, or some other form of mobile computing device configured to function in a same, or similar, manner as mobile device 104 described above. Additionally, or alternatively, one or more blocks of method 1400 may be performed, or facilitated, by a remotely controllable media device configured to facilitate two-way communications, such as a smart speaker, television, and/or hub device including one or more speakers, a display, one or more cameras, and/or one or more microphone. While not illustrated, method 1400 may begin with, or otherwise include some or all of the same blocks as method 800 described above. For example, prior to block 1404, method 1400 may include steps associated with detecting the remotely controllable media device, determining that the mobile device is in a handheld position, and determining that the mobile device is pointing at the remotely controllable media device.

Method 1400 may include, at block 1404, monitoring for a point-and-gesture to remote devices by a mobile device. Monitoring for a point-and-gesture may include measuring the distance and direction from the mobile device to one or more remotely controllable devices. Additionally, or alternatively, monitoring for a point-and-gesture may include monitoring changes in orientation of the mobile device as measured by one or more motion sensors and/or may be determined based on changes to the distance and/or direction from the mobile device to one or more remotely controllable devices.

At decision block 1408, it is determined whether a prescribed point-and-gesture was detected for a remote device. Determining that a prescribed point-and-gesture was detected for a remote device may include determining that the mobile device was moved according to a prescribed gesture while the mobile device was pointing toward the remote device. In some embodiments, determining that a prescribed point-and-gesture was detected for a remote device includes identifying the remote device from a plurality of devices. For example, before, during, or after detection of a gesture, it may be determined that the mobile device was pointing at two or more remote devices. A particular remote device from the plurality of remote devices may be identified for control based on a determination that the prescribed gesture is associated with the particular remote device, and/or a function exclusive to the remote device. If at decision block 1408, it is determined that a prescribed point-and-gesture was not detected, method 1400 may return to block 1404 to continue monitoring for a point-and-gesture.

At decision block 1412, in response to determining that a prescribed point-and-gesture was detected for a remote device, it is determined whether a user is on a call using the mobile device. As described above in reference to method 1100, a call may include any form of two-way communications, including voice and/or video calls between two or more participants. Determining whether a user is on a call may include determining whether an application configured to provide communication services is currently operating on the mobile device. Additionally, or alternatively, an operating system of the mobile device may include an indicator audio and/or visual communication is ongoing. A component of the mobile device configured to interface with remote devices, such as remote device interface 788 described above, may then query the operating system for the indicator to determine that a user is on a call.

At block 1416, in response to determining that a user is not on a call using the mobile device, a widget for other controllable functions of the remote device is shown on the mobile device. For example, as described above in reference to method 1200, the mobile device may display one or more music and/or media playlist, control, and/or transfer widgets. As another example, upon determining that the remote device is currently facilitating a call, one or more widgets may be shown to control and/or transfer the call to another remote device or to the mobile device. After completion of block 1416, method 1400 may return to block 1404 to continue monitoring for a subsequent point-and-gesture.

At block 1420, in response to determining that a user is on a call using the mobile device, a widget for transferring the call from the mobile device to the remote device is shown. The widget may include one or more GUI elements (e.g., buttons, drop down lists, and the like) indicating the availability of the remote device to become the interface for the call. Additionally, or alternatively, the widget may include one or more options and/or indicia that a component of the call (e.g., audio, video, outgoing communication, and/or incoming communication) may be, or may only be, transferred to the remote device. For example, a remote device including a display and speakers but lacking a camera and microphone may only be configured to receive the incoming components of an audio or video call while capture and/or transmission of the outgoing components must remain on the mobile device. As another example, a remote device including a speaker and microphone may only be configured to transmit and receive the audio components of a video call while the video components of the video call must remain on the mobile device. In some embodiments, the mobile device determines the available capabilities of the remote device in response to detecting the prescribed point-and-gesture. For example, after determining that a point-and-gesture has been made toward a remote device, the mobile device may determine a type for the remote device indicating the available functions of the remote device. As another example, the mobile device may determine that the remote device is currently engaged in one or more operations using at least a subset of the functions required to receive all of the components of the call. In some embodiments, the mobile device is further configured to monitor for one or more subsequent gestures associated with a selectable option to transfer the call, or components of the call, to the remote device. The subsequent gesture may achieve the same result as a selection of the selectable option via the widget.

At decision block 1424, it is determined whether to transfer the call to the remote device. A determination that the call is to be transferred may be made in response to receiving a selection via the widget to transfer the call and/or by detecting a subsequent gesture associated with such a selection via the widget. If at block 1424 it is determined that the call is not to be transferred, method 1400 may return to block 1404 to begin monitoring for a subsequent point-and-gesture to the same, or another, remote device.

At decision block 1428, in response to determining that the call is to be transferred to the remote device, the call is transferred to the remote device. As described above, transferring the call may include transferring some or all of the components of the call including the audio, video, incoming, and/or outgoing communications. Transferring the call may further include a bi-directional streaming of the data associated with the call between the mobile device and the remote device for ultimate transmission and reception by the mobile device to/from the source (e.g., a cellular tower, internet service, and the like). Alternatively, transferring the call may include transmitting information associated with the call configured to enable the remote device to transmit and/or receive the components of the call directly from the source. After completion of block 1428, method 1400 may return to block 1404 to begin monitoring for a subsequent point-and-gesture to the same, or another, remote device.

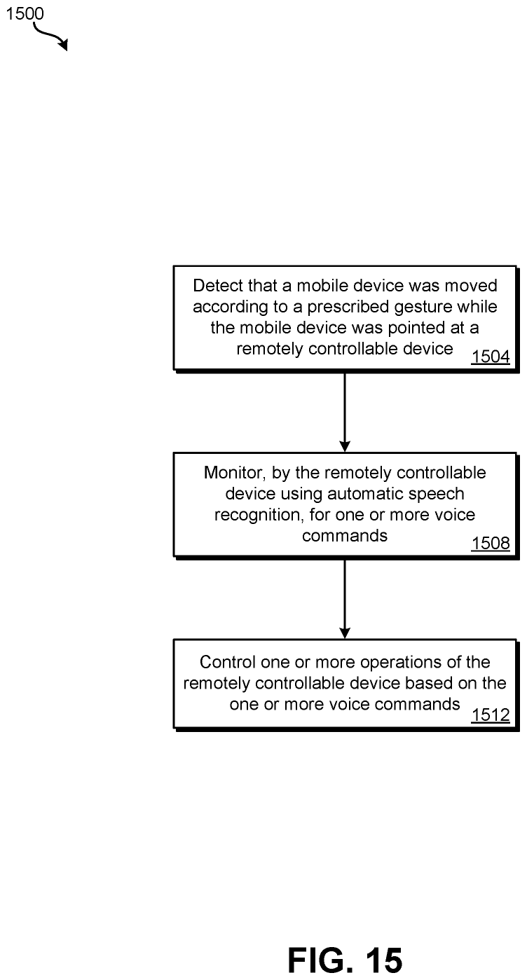

FIG. 15 illustrates an embodiment of a method 1500 for initiating voice command control over a remotely controllable device from a mobile device. Method 1500 may be performed using mobile device 104, or some other form of mobile computing device configured to function in a same, or similar, manner as mobile device 104 described above. Additionally, or alternatively, one or more blocks of method 1500 may be performed, or facilitated, by a remotely controllable device configured to record audio corresponding with spoken words and translate the recorded audio into voice command, such as hub device 120, smart speaker 116, and/or television 112, as described above. While not illustrated, method 1500 may begin with, or otherwise include some or all of the same blocks as method 800 described above. For example, prior to block 1504, method 1500 may include steps associated with detecting the remotely controllable device, determining that the mobile device is in a handheld position, and determining that the mobile device is pointing at the remotely controllable media device.

At block 1504, movement of a mobile device according to a prescribed gesture is detected while the mobile device was pointed at a remotely controllable device. As described above, the mobile device may detect that it was moved according to the prescribed gesture based at least in part on one or more changes in orientation or movement of the mobile device. After detecting that the mobile device was moved according to the prescribed gesture, the mobile device may determine whether the prescribed gesture was made while the mobile device was pointing at the remotely controllable device. In some embodiments, the mobile device identifies the remotely controllable device for control by the mobile device from a plurality of remotely controllable devices detected in the surrounding environment based on a determination that the mobile device was pointed at the remotely controllable device when the prescribed gesture was detected. Additionally, or alternatively, the mobile device identifies a remotely controllable device from a plurality of remotely controllable devices detected in the direction toward which the mobile device was pointing in based on a determination that the detected gesture is associated with the remote device.

At block 1508, one or more voice commands are monitored for by the remotely controllable device using automatic speech recognition (ASR). The remotely controllable device may begin monitoring for the one or more voice commands in response to the detection by the mobile device of the prescribed gesture while the mobile device was pointed at the remotely controllable device. For example, after detecting a prescribed gesture associated with activating a voice assistant, the mobile device may transmit a command signal to the remotely controllable device to begin recording audio for one or more ASR processes of the voice assistant.

In some embodiments, after detecting a prescribed gesture associated with activating a voice assistant, the voice assistant is activated on another device to which the mobile device was not pointing when the gesture was made. For example, after detecting the prescribed gesture associated with activating a voice assistant, the mobile device may determine that the device toward which the mobile device is pointing does not include a voice assistant function. In response, the mobile device may identify a second device within the environment that does include a voice assistant function and transmit the command signal to the second device to activate the voice assistant. Additionally, or alternatively, upon receiving the command to activate a voice assistant, the remote device may identify the second device and forward the command to the second device.

In some embodiments, identifying a different device to which the voice assistant command will be sent includes identifying the voice assistant enabled device that is in closest proximity to the mobile device or the remote device. For example, based on the location of the remote device, and/or the distance between the remote device and the mobile device, the mobile device may transmit the command to the voice assistant enabled device based on a previous determination of the distance between the remote device and the voice assistant enabled device. As another example, the mobile device may identify the voice assistant enabled device from a list of devices detected within the surrounding environment by the mobile device during a recent scan of the environment.

In some embodiments, method 1500 further includes causing one or more other devices in the surrounding environment to stop monitoring for voice commands. For example, after receiving a command signal from the mobile device to begin monitoring for the one or more voice commands, the remotely controllable device may transmit subsequent commands to nearby devices to stop monitoring for voice commands. Limiting the number of devices listening for voice demands to the remotely controllable device toward which the mobile device was pointing when the prescribed gesture was made may enable a user to specify a particular device for which the one or more voice commands are to be executed.

In some embodiments, the remotely controllable device performs some or all of ASR processing to generate the one or more voice commands from recorded audio corresponding to spoken language. Additionally, or alternatively, the remotely controllable device may transmit audio recorded by the remotely controllable device to a remote processing system for translation into corresponding voice commands actionable by the remotely controllable device.

At block 1512, one or more operations of the remotely controllable device are controlled based on the one or more voice commands. As described above, the remotely controllable device may receive one or more commands from a remote ASR processing system translated from the recorded audio. Alternatively, the remotely controllable device may receive the one or more commands from the voice assistant enabled device from which the voice commands were recorded. In response to receiving the commands, the remotely controllable device may determine whether the commands are actionable by the remotely controllable device. For example, the remotely controllable device may determine whether one or more of the commands correspond to functionalities and/or features not included or supported by the remotely controllable device. In some embodiments, the remotely controllable device identifies alternative devices in communication with the remotely controllable device by which the one or more commands may be executed, and/or the device specified in the commands as determined from the recorded voice commands and transmits the applicable commands to the respective device(s).

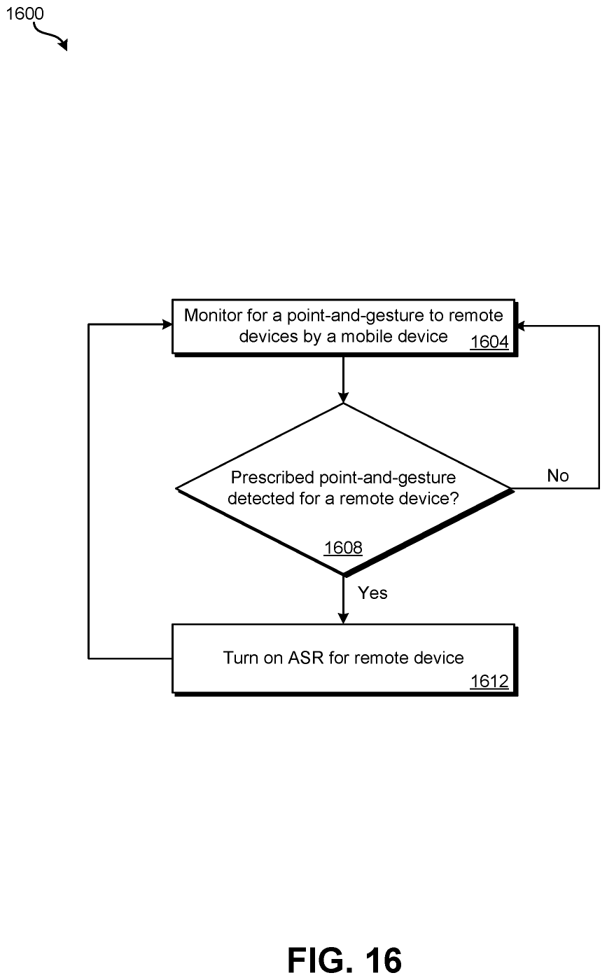

FIG. 16 illustrates another embodiment of a method 1600 for initiating voice command control over a remotely controllable device from a mobile device. Method 1600 may be performed using mobile device 104, or some other form of mobile computing device configured to function in a same, or similar, manner as mobile device 104 described above. Additionally, or alternatively, one or more blocks of method 1600 may be performed, or facilitated, by a remotely controllable device configured to record audio corresponding with spoken words and translate the recorded audio into voice command, such a smart speaker, voice enabled television, and/or hub device including one or more speakers, and one or more microphones. While not illustrated, method 1600 may begin with, or otherwise include some or all of the same blocks as method 800 described above. For example, prior to block 1604, method 1600 may include steps associated with detecting the remotely controllable device, determining that the mobile device is in a handheld position, and determining that the mobile device is pointing at the remotely controllable media device.

Method 1600 may include, at block 1604, monitoring for a point-and-gesture to remote devices by a mobile device. Monitoring for a point-and-gesture may include measuring the distance and direction from the mobile device to one or more remotely controllable devices. Additionally, or alternatively, monitoring for a point-and-gesture may include monitoring changes in orientation of the mobile device as measured by one or more motion sensors and/or may be determined based on changes to the distance and/or direction from the mobile device to one or more remotely controllable devices.

At decision block 1608, it is determined whether a prescribed point-and-gesture was detected for a remote device. Determining that a prescribed point-and-gesture was detected for a remote device may include determining that the mobile device was moved according to a prescribed gesture while the mobile device was pointing toward the remote device. In some embodiments, determining that a prescribed point-and-gesture was detected for a remote device includes identifying the remote device from a plurality of devices. For example, before, during, or after detection of a gesture, it may be determined that the mobile device was pointing at two or more remote devices. A particular remote device from the plurality of remote devices may be identified for control based on a determination that the prescribed gesture is associated with the particular remote device, and/or a function exclusive to the remote device. If at decision block 1608, it is determined that a prescribed point-and-gesture was not detected, method 1600 may return to block 1604 to continue monitoring for a point-and-gesture.

At block 1612, in response to determining that a prescribed point-and-gesture was detected for a remote device, an ASR is turned on for the remote device. The remote device may begin monitoring for the one or more voice commands in response to the detection by the mobile device of the prescribed gesture while the mobile device was pointed at the remote device. For example, after detecting a prescribed gesture associated with activating a voice assistant, the mobile device may transmit a command signal to the remotely controllable device to begin recording audio for one or more ASR processes of the voice assistant.

In some embodiments, after detecting a prescribed gesture associated with activating a voice assistant, the voice assistant is activated on another device to which the mobile device was not pointing when the gesture was made. For example, after detecting the prescribed gesture associated with activating a voice assistant, the mobile device may determine that the device toward which the mobile device is pointing does not include a voice assistant function. In response, the mobile device may identify a second device within the environment that does include a voice assistant function and transmit the command signal to the second device to activate the voice assistant. Additionally, or alternatively, upon receiving the command to activate a voice assistant, the remote device may identify the second device and forward the command to the second device.

In some embodiments, identifying a different device to which the voice assistant command will be sent includes identifying the voice assistant enabled device that is in closest proximity to the mobile device or the remote device. For example, based on the location of the remote device, and/or the distance between the remote device and the mobile device, the mobile device may transmit the command to the voice assistant enabled device based on a previous determination of the distance between the remote device and the voice assistant enabled device. As another example, the mobile device may identify the voice assistant enabled device from a list of devices detected within the surrounding environment by the mobile device during a recent scan of the environment.

In some embodiments, method 1600 further includes causing one or more other devices in the surrounding environment to stop monitoring for voice commands. For example, after receiving a command signal from the mobile device to begin monitoring for the one or more voice commands, the remote device may transmit subsequent commands to nearby devices to stop monitoring for voice commands. Limiting the number of devices listening for voice demands to the remote device toward which the mobile device was pointing when the prescribed gesture was made may enable a user to specify a particular device for which the one or more voice commands are to be executed.

In some embodiments, the remote device performs some or all of ASR processing to generate the one or more voice commands from recorded audio corresponding to spoken language. Additionally, or alternatively, the remote device may transmit audio recorded by the remotely controllable device to a remote processing system for translation into corresponding voice commands actionable by the remotely controllable device (e.g., voice/display assistance server 112).

In some embodiments, one or more operations of the remote device are controlled based on the one or more voice commands detected from the recorded audio. As described above, the remote device may receive one or more commands from a remote ASR processing system translated from audio recorded by the remote device. In response to receiving the commands, the remote device may determine whether the commands are actionable by the remote device. For example, the remote device may determine whether one or more of the commands correspond to functionalities and/or features not included or supported by the remote device. In some embodiments, the remote device identifies alternative devices in communication with the remote device by which the one or more commands may be executed and proceeds to transmit the applicable commands to the respective alternative devices. After completion of block 1612, method 1600 may return to block 1604 to begin monitoring for a subsequent point-and-gesture to the same, or another, remote device.

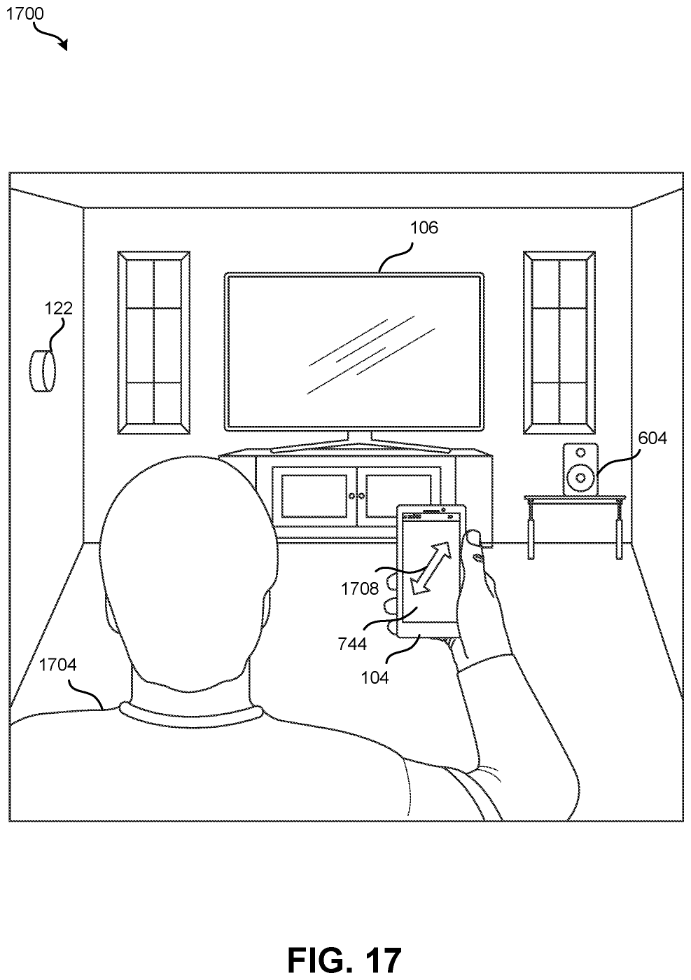

FIG. 17 illustrates an example of selecting one or more remote devices in a smart home environment 1700 for control by a mobile device in accordance with some embodiments. As illustrated, user 1704 may wish to remotely control one or more remote devices in and around environment 1700, such as smart thermostat 122, display 106, and/or smart speaker 604, from their mobile device 104. While not illustrated, environment 1700 may include additional devices, such as one or more hub devices, smart cameras, personal computing devices, and the like. Smart thermostat 122, display 106, and/or smart speaker 604 may function in the same, or similar, manner as described above. For example, one or more of smart thermostat 122, display 106, and/or smart speaker 604 may be configured to transmit and receive UWB messages useable to determine a distance and direction from the respective device to another device (e.g., a remote device and/or mobile device 104) that is similarly UWB enabled. As another example, the devices of environment 1700 may be remotely controllable by receiving one or more types of wireless command signals (e.g., via a Wi-Fi, Bluetooth®, mesh network, etc.).

Mobile device 104 may include some or all of the same components discussed above. For example, mobile device 104 may include display 744 configured to enable user 1704 to interact with mobile device 104. As another example, mobile device 104 may include one or more software components configured to determine an orientation of mobile device, such as orientation engine 772, detect one or more prescribed gestures, such as gesture engine 776, determine whether mobile device 104 is in a handheld position (e.g., as illustrated), such as handheld detector 780, determine whether mobile device 104 is pointing towards a remotely controllable device, such as remote device mapper 784, and transmit one or more command signals to a remotely controllable device, such as remote device interface 788.

As further described above, after determining that mobile device 104 is in a handheld position and/or in a predefined orientation (e.g., with a vertical axis substantially parallel with gravity, as illustrated), mobile device 104 may begin monitoring for a prescribed gesture associated with initiating control of a remotely controllable device. Display 1708 may present an exemplary gesture 1708 to user 1704 with one or more instructions describing how to move mobile device 104 according to the gesture 1708 associated with initiating control of a remote device. For example, as illustrated, the prescribed gesture associated with initiating control of a remote device may include moving mobile device 104 toward and/or away from the remote device for which control is intended.

Additionally, or alternatively, display 1708 may present an indication of the remotely controllable devices detected within the vicinity of mobile device 104 (e.g., as detected using a UWB interface, such as UWB interface 764). For example, mobile device 104 may present a list of devices including smart thermostat 122, display 106, and smart speaker 604. Additionally, or alternatively, mobile device 104 may highlight, or otherwise indicate, a remote device from a list of remote devices in the vicinity of mobile device 104 at which it has been determined that mobile device 104 is pointing.

After detecting that mobile device 104 has been moved according to gesture 1708 while pointing at a remote device (e.g., smart speaker 604), mobile device 104 may display an indication that a connection to the remote device has been established. Additionally, or alternatively, mobile device 104 may display a GUI including one or more selectable actions for controlling the remote device, as described further below.

To begin controlling a different remote device within environment 1700, user 1704 may proceed to point mobile device 104 toward the intended device and initiate control of the device by again moving mobile device 104 according to gesture 1708. Mobile device 104 may stop controlling a particular remote device in response to detecting a subsequent prescribed gesture. For example, after detecting that mobile device 104 has been moved according to a prescribed gesture associated with terminating control of a remote device, mobile device 104 may return to one or more operations and/or one or more GUIs being executed prior to establishing a connection with a remotely controllable device. Additionally, or alternatively, mobile device 104 may stop controlling a device after determining that mobile device 104 is no longer in a predetermined orientation, in a handheld position, pointing at a remote device, and the like.

While the detection of the prescribed gesture described above is associated with initiating control of a remote device, other embodiments are similarly applicable. For example, in response to detecting a prescribed gesture associated with a particular function of a remote device, the mobile device may automatically cause the mobile device to begin operating in accordance with the particular function. As illustrated, a particular function associated with smart speaker 604 may include controlling and/or transferring media playback to/from the remote device. As another example, in response to detecting a prescribed gesture associated with a particular capability of the remote device, the mobile device may display one or more GUIs configured to control the particular capability. Such capabilities may include audio and/or video playback, ASR, and the like.

FIG. 18 illustrates an example interface for controlling remote devices from a mobile device in accordance with some embodiments. As described above, after establishing a connection with a remote device, and/or detecting a prescribed gesture associated with a particular function of the remote device, display 744 may display one or more GUIs including one or more selectable options for controlling the remote device. For example, as illustrated, after establishing a connection with smart speaker 608 in response to detecting a prescribed gesture while mobile device 104 was pointed at smart speaker 608, display 744 may present one or more selectable options to control one or more operations of smart speaker 608. In the illustrated example of controlling smart speaker 608, the one or more selectable options associated with smart speaker 608 can include volume controls 1818, media playback controls 1822, and media playback transfer controls 1826. Mobile device 104 may display similar controls for other types of media playback devices, such as display 106.

In response to receiving a selection of one of the one or more selectable options, a remote device interface, such as remote device interface 788 described above, may transmit a corresponding command signal to the remote device to control an operation of the remote device. For example, upon selection of media playback transfer controls 1826, the playback of media currently playing on mobile device 104 may be transferred to smart speaker 608, or vice versa. As another example, in response to detecting an input, such as clockwise rotation gesture 1838, associated with selectable option 1834, media playback of a currently playing media track by smart speaker 608 may be advanced to a subsequent media track. As described above, additional gestures may be associated with respective selectable options included in a graphical user interface. Additional, or alternative, user inputs may be associated with the selectable options, such as one or more voice commands, or one or more physical user interface interactions (e.g., button selections).

While not illustrated, the one or more selectable options to control the one or more operations of a remote device may be specific to a particular device being controlled. For example, the one or more selectable options associated with a smart thermostat, such as smart thermostat 122 may include a slider and/or one or more buttons corresponding to setpoint temperature adjustment controls. As another example, the one or more selectable options associated with a smart camera, such as smart camera 132 may include media playback controls configured to enable a user to playback current and/or historical audio and/or visual recordings captured by the smart camera on mobile device 104.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

1. A method for controlling a remotely controllable device comprising:
detecting, by a mobile device, a remotely controllable device;
determining, by the mobile device, that the mobile device is in a handheld position;
measuring, by the mobile device, using a first wireless communication protocol, a distance and a direction from the mobile device to the remotely controllable device;
determining, from the distance and the direction, that the mobile device is pointing at the remotely controllable device;
in response to determining that the mobile device is in the handheld position, that the mobile device is pointing at the remotely controllable device, or both, beginning to monitor, by the mobile device, for a movement of the mobile device according to a prescribed gesture;
detecting, by the mobile device, that the mobile device was moved according to the prescribed gesture while the mobile device was pointed at the remotely controllable device;
initiating, by the mobile device, a connection between the mobile device and the remotely controllable device in response to detecting that the mobile device was moved according to the prescribed gesture while the mobile device was pointed at the remotely controllable device; and
presenting, at a display of the mobile device and in further response to detecting that the mobile device was moved according to the prescribed gesture, a first collection of selectable actions to control one or more operations of the remotely controllable device via the connection.

2. The method for controlling the remotely controllable device of claim 1, further comprising:
in response to determining that the mobile device is in the handheld position, increasing a scan rate of a first wireless communication component of the mobile device associated with the first wireless communication protocol from a first frequency to a second frequency higher than the first frequency.

3. The method for controlling the remotely controllable device of claim 1, further comprising:
detecting, by the mobile device using a motion sensor, one or more movements of the mobile device, wherein determining that the mobile device is in the handheld position is based at least in part on the one or more movements of the mobile device.

4. The method for controlling the remotely controllable device of claim 1, further comprising:
receiving, at the display of the mobile device, a selection of a first action of the first collection of selectable actions corresponding to a first operation of the one or more operations; and
in response to receiving the selection of the first action, transmitting, by the mobile device using a second wireless communication protocol different from the first wireless communication protocol, a command to control the first operation of the remotely controllable device via the connection.

5. The method for controlling the remotely controllable device of claim 1, further comprising:
detecting, by the mobile device, that the mobile device was moved according to a second prescribed gesture associated with a first action of the first collection of selectable actions corresponding to a first operation of the one or more operations while the mobile device was pointed at the remotely controllable device; and
in response to detecting that the mobile device was moved according to the second prescribed gesture, transmitting, by the mobile device using a second wireless communication protocol different from the first wireless communication protocol, a command to control the first operation of the remotely controllable device via the connection.

6. The method for controlling the remotely controllable device of claim 1, further comprising:
detecting, by the mobile device, a plurality of remotely controllable devices comprising the remotely controllable device;
determining that the mobile device is pointing at a second remotely controllable device of the plurality of remotely controllable devices;
detecting, by the mobile device, that the mobile device was moved according to the prescribed gesture while the mobile device was pointed at the second remotely controllable device; and
presenting, at the display of the mobile device, a second collection of selectable actions to control one or more operations of the second remotely controllable device.

7. The method for controlling the remotely controllable device of claim 1, further comprising:
detecting, by the mobile device, a second remotely controllable device; and
measuring, by the mobile device, a second distance and a second direction from the mobile device to the second remotely controllable device, wherein:
determining that the mobile device is pointing at the remotely controllable device is further based on the second distance and the second direction from the mobile device to the second remotely controllable device, and a third distance from the remotely controllable device to the second remotely controllable device.

8. The method for controlling the remotely controllable device of claim 1, further comprising:
determining, by the mobile device, that the mobile device is approved to control the remotely controllable device, wherein the first collection of selectable actions are presented in further response to determining that the mobile device is approved to control the remotely controllable device.

9. The method for controlling the remotely controllable device of claim 1, wherein the first wireless communication protocol uses ultra-wideband communications between devices.

10. A smart environment system, comprising:
a remote device configured to be controlled remotely via one or more wireless communication protocols; and
a mobile device comprising one or more processors and a memory communicatively coupled with and readable by the one or more processors and having stored therein processor-readable instructions which, when executed by the one or more processors, cause the one or more processors to:
detect the remote device;
determine that the mobile device is in a handheld position;
measure, using a first wireless communication protocol of the one or more wireless communication protocols, a distance and direction from the mobile device to the remote device;
determine, from the distance and the direction, that the mobile device is pointing at the remote device;
begin to monitor, in response to determining that the mobile device is in the handheld position, that the mobile device is pointing at the remote device, or both, for a movement of the mobile device according to a prescribed gesture;
detect that the mobile device was moved according to the prescribed gesture while the mobile device was pointed at the remote device;
initiate a connection between the mobile device and the remote device in response to detecting that the mobile device was moved according to the prescribed gesture while the mobile device was pointed at the remote device; and
present, at a display of the mobile device and in further response to detecting that the mobile device was moved according to the prescribed gesture, a first collection of selectable actions to control one or more operations of the remote device via the connection.

11. The smart environment system of claim 10, further comprising a plurality of remote devices comprising the remote device, and wherein the instructions further cause the one or more processors to:
detect the plurality of remote devices; and
measure, using the first wireless communication protocol, respective distances and directions from the mobile device to each of the plurality of remote devices.

12. The smart environment system of claim 10, further comprising a hub device configured to transmit one or more commands from the mobile device to the remote device via the connection in response to a user selection of a first action of the first collection of selectable actions, and wherein the instructions further cause the one or more processors to:
determine a second distance and a second direction from the mobile device to the hub device, wherein determining that the mobile device is pointing at the remote device is further based on the second distance and the second direction from the mobile device to the hub device, and a third distance from the remote device to the hub device.

13. The smart environment system of claim 10, wherein the remote device is a smart speaker configured to control media playback and the first collection of selectable actions includes a first action that causes a transfer of media playback by the mobile device to the smart speaker.

14. The smart environment system of claim 10, wherein the remote device is a smart thermostat configured to control one or more operations of a heating, ventilation, and air-conditioning (HVAC) system, and the first collection of selectable actions includes a first action that causes the smart thermostat to adjust a setpoint temperature associated with the HVAC system.

15. The smart environment system of claim 10, wherein the remote device is a security camera configured to record audio, video, or both, in a physical environment and the first collection of selectable actions includes a first action that causes the mobile device to display historical audio, video, or both recorded by the security camera.

16. A non-transitory processor-readable medium,
comprising processor-readable instructions configured to cause one or more processors to:
detect, by a mobile device, a remotely controllable device;
determine that the mobile device is in a handheld position;
measure a distance and a direction from the mobile device to the remotely controllable device using a first wireless communication protocol;
determine, from the distance and the direction, that the mobile device is pointing at the remotely controllable device;
in response to the determination that the mobile device is in the handheld position, the determination that the mobile device is pointing at the remotely controllable device, or both, begin to monitor for a movement of the mobile device according to a prescribed gesture;
detect that the mobile device was moved according to the prescribed gesture while the mobile device was pointed at the remotely controllable device;
initiate a connection between the mobile device and the remotely controllable device in response to detecting that the mobile device was moved according to the prescribed gesture while the mobile device was pointed at the remotely controllable device; and
present, at a display of the mobile device and in further response to the detection that the mobile device was moved according to the prescribed gesture, a first collection of selectable actions to control one or more operations of the remotely controllable device via the connection.

17. The non-transitory processor-readable medium of claim 16, wherein, in response to the determination that the mobile device is in the handheld position, the processor-readable instructions are further configured to cause the one or more processors to increase a scan rate of a wireless communication component associated with the first wireless communication protocol from a first frequency to a second frequency higher than the first frequency.

18. The non-transitory processor-readable medium of claim 16, wherein the processor-readable instructions are further configured to cause the one or more processors to:
detect, using a motion sensor, one or more movements of the mobile device, wherein the determination that the mobile device is in the handheld position is based at least in part on the one or more movements of the mobile device.

19. The non-transitory processor-readable medium of claim 16, wherein the processor-readable instructions are further configured to cause the one or more processors to:
receive a selection of a first action of the first collection of selectable actions corresponding to a first operation of the one or more operations; and
in response to receiving the selection of the first action, transmit, using a second wireless communication protocol different from the first wireless communication protocol, a command to control the first operation of the remotely controllable device via the connection.

20. The non-transitory processor-readable medium of claim 16, wherein the first wireless communication protocol is an ultra-wideband communication protocol.
